(19) United States
(12) Patent Application Publication
(10) Pub. No.: US 2004/0117206 A1
(43) Pub. Date: Jun. 17, 2004

(54) Natural procedure labels controlled for coding

(76) Inventors: Daniel Steinberger, Maplewood, MN (US); Michael G. McMurty, Bangor, WI (US); Steve R. Claypool, Minneapolis, MN (US); Scott A. Hollington, Plymouth, MN (US); Ying Ching Yu, Roseville, MN (US); Sean C. Benson, Minneapolis, MN (US); Peter E. Crist, Rockford, MN (US); Allison S. Errickson, Minneapolis, MN (US); Linda R. Peitzman, Eden Prairie, MN (US); David A. Del Toro, Woodbury, MN (US)

Correspondence Address: Mara E. Liepa, Merchant & Gould P.C., P.O. Box 2903, Minneapolis, MN, 55402-0903, US

(21) Appl. No.: 10/442,406

(22) Filed: May 21, 2003

Related U.S. Application Data
(60) Provisional application No. 60/433,625, filed on Dec. 13, 2002.

(51) Int. Cl. G06F 17/60; G06F 7/00; G06F 17/00

(52) U.S. Cl. 705/2; 707/104.1

(57) ABSTRACT

A computer-based system and method are described for generating a natural procedure label to summarize a clinical procedure description recorded into the system by a physician. The system and method manipulate a set of database records comprising medical content which is naturally descriptive of clinical procedures and which is controlled for coding to generate the natural procedure label and its corresponding non E & M Current Procedure Terminology (CPT) code during the recording the procedure description. To support the generation of a set of said natural procedure labels, the system and method provide interchangeable, connected, ontologically-based medical procedure database cartridges of medical content terms and rules that naturally describe constrained procedure representations for clinical procedure descriptions.

### CROSS-REFERENCE TO RELATED APPLICATIONS

This application claims priority under 35 U.S.C. § 119(e) to U.S. Provisional Application No. 60/433,625, filed Dec. 13, 2002. The complete disclosure of application Serial No. 60/433,625 is incorporated by reference herein.

### FIELD OF THE INVENTION

The field of the present invention generally relates to systems and methods for medical procedure documentation, and in particular to a system and method for generating naturally expressed medical procedure descriptions in unique association to Current Procedural Terminology (CPT) billing codes for all non Evaluation and Management (E & M) CPT codes.

### BACKGROUND OF THE INVENTION

Medical billing has become increasingly more complicated and time consuming. Medicare and other third-party payors are requiring CPT codes and supporting documentation to be recorded for each procedure performed on a patient. Medical billing is based on two kinds of billing codes: the diagnosis code and the procedure code. The diagnosis code represents the patient's diagnosed illness or malady and the procedure code represents what medical procedure was actually performed on the patient. The World Health Organization has developed a method to identify the patient's diagnosed conditions and injuries, and the associated codes are called the International Classification of Diseases 9th edition Clinical Modification (ICD9) codes. Similar codes will likely be adopted in the future as the ICD10 codes are already published. A uniform language for effective communication of procedure codes was developed by the American Medical Association (AMA) in 1966 and is called the Current Procedural Terminology (CPT). In 1983, the Centers for Medicare and Medicaid Services (CMS), formerly the Health Care Financing Administration (HCFA), created the Healthcare Common Procedure Coding System (HCPCS) or “hick-picks” system. The HCPCS system is a uniform method for health care providers and medical suppliers to report professional services, procedures, and supplies. The HCPCS system is further categorized into three levels. Level I is the AMA Physician's Current Procedural Terminology (CPT), Level II is the HCPCS national codes, and Level III is local codes maintained by individual state Medicare carriers. The HCPCS Level III codes are just one part of the three-level coding system which will soon become a two-level coding system. The Health Insurance Portability Accountability Act (HIPAA) requires that there be standardized procedure coding. In order to meet this requirement all HCPCS Level III codes/modifiers need to be eliminated by Dec. 31, 2003.

A third party payor is an organization, carrier, or intermediary that supplies insurance, especially health insurance (including Medicare), to individuals. Third party payors now require that the appropriate ICD9, CPT, and HCPCS codes be assigned to each and every patient encounter, evaluation, examination, and procedure between a patient and a physician, assistant, nurse or other health care provider. These codes encompass the complexity of the problem evaluated, the amount of work required of the physician, and the level of treatment required. Accordingly, physicians must code all services, and in particular procedures, according to the CPT coding system to be paid for their services from these organizations. Therefore, billing for a physician's services has become increasingly more complex in recent years.

To manage this increasing complexity, groups such as Medicare and independent companies such as the Physician Management Information Company (PMIC) have developed categorizations of various parts of the patient encounter. These aids usually take the form of checklists on letter or legal sized papers. They are often several pages long and serve to aid the provider in choosing the accurate procedure code. Medical specialists find the CPT coding system difficult to use because many modern medical specialties fall within several enumerated categories. Further, the CPT coding system requires a working knowledge of the medical procedures involved to receive proper compensation, thereby causing non-physician coding personnel to sometimes improperly code examinations. Many procedures that are performed but not documented by the physician go unbilled and un-reimbursed because the non-physician coding personnel do not fully understand the medical procedures involved or because there is insufficient information provided by the physician in the procedural notes. Furthermore, even if a non-physician coding personnel coding the examinations understands the procedures involved, he or she is likely to overlook billable intermediate procedures. Thus, constructing a complete and concise set of CPT codes for procedures is complicated and problematical without a deep understanding of each medical procedure, the various ways each procedure can be described, and the associated arcane nomenclature used by the CPT coding system that matches each possible procedure description.

Additionally, physicians and non-physician coding personnel often do not accurately translate a performed medical procedure into the correct CPT coding format because of the very complexity of the CPT coding system itself. In many situations, a straight reading of the CPT code will not provide the proper billing code, and the physician or non-physician coding personnel must review an entire CPT category to determine the proper billing code, or must memorize how certain procedural codes interact. Memorizing all of the CPT codes and coding interactions applicable to a physicians' practice, however, is impractical, and using a truncated, but manageable, list would be incomplete and inaccurate. The CPT coding system is also imprecise in areas, and the physician or non-physician personnel must learn to compensate for this inexactness. These issues are exacerbated by the fact that the CPT codes commonly change from year to year. The CPT code interactions change as often as quarterly via the National Correct Coding Initiatives, (NCCl).

To effectively handle these issues, a medical coding profession was established to translate procedural descriptions used by their hospital's physician groups to an appropriately matched CPT. Nonetheless, because of the incredible, dynamic complexity of the CPT coding system, payments from Medicare and private insurance companies regularly lack parity with the physician's services.

There are systems and methods that address these issues. However, the prior art does not sufficiently address the issues to provide an efficient and effective means to solve these problems for non E & M CPT coding nor does the prior art address the issue of a consistent complete natural description of a medical procedure used by physicians. Furthermore, there does not exist a prescribed and predetermined relationship between the natural procedure description used by physicians and the non E & M CPT codes. A structured language bridge or ontology does not exist that uniquely matches up the natural procedure description used by the physicians and the language utilized in the non E & M CPT coding systems.

There are system systems that attempt to solve these problems. As an example, CodeLink is a system package developed by Context System Systems that compares CPT codes typed by the user to ICD9 codes or vice versa. The two codes are compared based on the medical necessity established by HCFA. The codes are not generated as part of a real-time documentation process but as a separate, stand-alone reference after the encounter. As another example, PRISM is system package that documents the medical encounter. PRISM's Patient Registration module prints a list of CPT and ICD9 codes selected by the physician. A significant limitation is that this list is not related to the patient-specific encounter.

U.S. Pat. No. 6,529,876 to Dart et al. describes a system for the production of accurate billing coding for care rendered. The invention established the process, the data gathering and documentation required of a provider in determining and documenting correct Evaluation and Management, (E & M), CPT code required for agency reimbursement for care delivered. This system only produces E & M CPT codes and does not produce non E & M CPT codes.

U.S. Pat. No. 5,483,443 to Milstein et al. describes a system for calculating a Current Procedural Terminology (“CPT”) code from input received from a physician or other medical professional. The physician is prompted with lists of choices corresponding to a patient's medical status. This system only produces E & M CPT codes and does not produce non E & M CPT codes.

U.S. Pat. No. 5,325,293 to Dome describes a system for performing the inventive method are provided to correlate billing code with planned or performed medical procedures. The method comprises the steps of determining raw codes directly associated with all of the medical procedures performed or planned to be performed with a particular patient examination, and manipulating the raw codes by the steps of a final common pathway to generate intermediate codes without altering the raw codes. The method also comprises the step of determining the billing codes from the intermediate codes. This system produces non E & M CPT codes but doesn't provide a method that utilizes a structured natural procedure description used by physicians to generate the non E & M CPT code. The system directs the physician to document the procedure in an unstructured non-natural procedure description method.

It would therefore be advantageous to have a method and system for designing and implementing a naturally expressible medical procedural language that correctly and concisely describes a physician's procedure with a summary descriptor, such as a procedure note label, header, tag, or title. The naturally expressed summary descriptor would have a distinct correspondence between the physician's procedure and a unique non E & M CPT code associated with it. In this manner, physicians are able to describe their procedures in a clinical style that is natural to the physician with no requirement to understand or use the CPT coding system nomenclature.

None of the known prior documentation code association approaches are able to accomplish the noteworthy need of determining accurate codes during the documentation process, providing codes that are as accurate as possible, and doing this in an easy-to-use and automated manner for the physician.

The invention incorporates the desired coding into the procedure documentation process for a physician using the invention. The invention correctly and accurately links the procedure performed, the procedure documentation input by the physician, and the procedure codes.

The invention therefore provides consistent coding. The invention incorporates a set of rules that guarantee that specific criteria for each code are met or not met. By associating a CPT code to the procedure documentation, the invention provides a reliable method of coding the procedure and a sense of security for the provider that an accurate code has been presented for incorporation into the procedure note.

Accuracy is a significant factor when assigning the diagnosis and procedural codes. Human error may factor into any process where numbers are looked up in one source and transcribed into another. The object of the invention is to provide concise and complete procedure documentation system that automates the generation of associated accurate CPT codes. The system allows the physician to select the textual descriptions of procedure terms and attributes as an integral part of documenting the procedure in a manner that is natural and is uniform for all procedure notes generated by the invention. The CPT codes are automatically coupled to the natural procedure label and procedure descriptions.

Thus, as will be appreciated from a review of the drawings and detailed descriptions of the preferred embodiments, the present invention overcomes the significant limitations and shortcomings of the prior art.

### SUMMARY OF THE INVENTION

The benefits of this invention will become clear and will be best appreciated with reference to the detailed description of the preferred embodiments. Other objects, advantages, and novel features will be apparent from the description when read in conjunction with the appended claims and attached drawings.

The present invention is an automated medical procedure documentation and code compliance system and method. The invention generates thorough, medically complete, procedure notes that are coupled with accurate non E & M CPT procedure codes.

A computer based system and method are described for generating a natural procedure label that summarize a clinical procedure description recorded into the system by a physician. The system and method manipulate a set of database records comprising medical content which is naturally descriptive of clinical procedures and which is controlled for coding to generate the natural procedure label and its corresponding Current Procedural Terminology (CPT) code during the recording of the procedure description.

The system provides the features that eliminate the error prone process of dictation, and the often lengthy delays associated with transcribing, reviewing, recreating, and approving transcripts. A minimal learning curve is required to become productive when using the invention.

The system eliminates the time required for coding specialists to decipher inadequate documentation to obtain proper reimbursements. The system simplifies the CPT coding process. The system codes each procedure completely, based on the physician's notes. The coding is done accurately and in a manner that makes it foolproof by engineering design. The system's document driven charge capture module completes the process by transferring the documentation to the healthcare facilities billing system. The system eliminates the problems relating to under coding and under billing. All legitimate revenues claims are properly and completely documented.

The present invention is a software program operating on a single general purpose computing device or a plurality of computing devices interconnected via a network system. The invention is a system and method for electronically documenting a medical procedure in a manner that generates a natural procedure label and an associated non E & M CPT code that automatically matches the correct non E & M CPT description for the medical procedure. Procedure notes are stored in a database, permitting retrieval of existing procedure documentation in seconds. The procedure documentation is readily available for review, print, fax, email operations.

The invention interface comprises a set of procedure descriptors designed as drop down menus that controls the information input by a physician to document a medical procedure. The invention uses an anticipatory physician interface, which emulates a typical procedural workflow and a clinician's thought processes, instantly and automatically adapting to each piece of information that is input by the physician.

A procedure description narrative is constructed based on the initial procedure category selected by a physician. As the physician documents the procedure using the anticipatory interface menus, the narrative is edited as the next procedure description item is selected from a next menu in the documentation process. At the completion of the procedure documentation process, the procedure description narrative is completed and its description fields are filled in. The completed procedure description narrative is called a natural procedure label for the medical procedure.

The system reduces the time spent by the physician paging through a maze of screens to find the correct place to record information. The system also reduces the time spent by the physician scrolling through dozens of pull-down menus or the time spent by the physician reading through endless lists of words in search for terminology appropriate for the procedure at hand.

### BRIEF DESCRIPTION OF THE DRAWINGS

The present invention can be better understood with reference to the following diagrams. The components within the drawings are not necessarily to scale relative to each other, emphasis instead being placed upon clearly illustrating the principles of the present invention.

FIG. 1 is a plan view of a computing device, in particular, a personal computer.

FIG. 2 is a plan view of a computing device, in particular, a laptop computer.

FIG. 3 is a plan view of a computing device, in particular, a pocket pc.

FIG. 4 is a plan view of a computing device, in particular, a tablet pc.

FIG. 5 is a plan view of a computing device, in particular, portable device monitor.

FIG. 6 is a plan view of a computing device, in particular, a data acquisition computer.

FIG. 7 is a plan view of a computing device, in particular, a stationary device monitor.

FIG. 8 is a graphical representation of a computing device, in particular, an image capture computer.

FIG. 9 is a schematic, graphical representation of a typical configuration of system architecture.

FIG. 10 is a schematic, graphical representation of physical connections in a typical configuration of a system within the healthcare facility.

FIG. 11 is a schematic, graphical representation of physical connections in a WAN and internet configuration of the system.

FIG. 12 is a graphical representation of logical connections between clients and servers.

FIG. 13 is a screen shot illustrating a physician logon screen for the system of the invention.

FIG. 14 is a screen shot illustrating a form that allows a physician to select a specialty for the procedure documentation.

FIG. 15 is a screen shot illustrating a main selection form for the launching of a procedure documentation component of the system of the invention.

FIG. 16 is a screen shot illustrating an anticipatory physician interface for the system of the invention.

FIG. 17 is a screen shot illustrating the scheduling component of the system of the invention.

FIG. 18 is a screen shot illustrating the system's physician interface after having selected a patient that has undergone a procedure.

FIG. 19 is a screen shot illustrating the system's physician interface prompting the physician for the procedure category for the procedure requiring documentation.

FIG. 20 is a screen shot illustrating the system's physician interface prompting the physician for the procedure name for the procedure requiring documentation.

FIG. 21 is a screen shot illustrating the system's physician interface prompting the physician for the first attribute for the procedure requiring documentation.

FIG. 22 is a screen shot illustrating the system's physician interface prompting the physician for the next attribute for the procedure requiring documentation.

FIG. 23 is a screen shot illustrating the system's physician interface prompting the physician for the next attribute for the procedure requiring documentation.

FIG. 24 is a screen shot illustrating the system's physician interface prompting the physician for the next attribute for the procedure requiring documentation.

FIG. 25 is a screen shot illustrating the system's physician interface displaying the completed natural procedure label.

FIG. 26 is a screen shot illustrating the system's physician interface displaying the coding form.

FIG. 27 is a screen shot illustrating the system's physician interface displaying the coding form and the natural procedure label.

FIG. 28 is a screen shot illustrating the system's physician interface displaying the natural procedure label and the associated coupled CPT code and description.

FIG. 29 is a screen shot illustrating the system's physician interface displaying the coding form outside the procedure documentation form

FIG. 39 is a schematic, graphical representation of a database server containing stored procedures and tables involved with invention.

FIG. 40 is a tabulated description of the stored procedures involved with invention.

FIG. 41 is a tabulated description of the Cdirect table and a representation of the data stored in the table that is accessed as part of the invention.

FIG. 42 is a tabulated description of the Dirpar table and a representation of the data stored in the table that is accessed as part of the invention.

FIG. 43 is a tabulated description of the Cdirmen table and a representation of the data stored in the table that is accessed as part of the invention.

FIG. 44 is a tabulated description of the Cmenu table and a representation of the data stored in the table that is accessed as part of the invention.

FIG. 45 is a tabulated description of the Cmenent table and a representation of the data stored in the table that is accessed as part of the invention.

FIG. 46 is a tabulated description of the Exam table

FIG. 47 is a tabulated description of the Cmenat2 table.

FIG. 48 is a tabulated description of the Cmentmp table.

FIG. 49A is a representation of data stored in tables that are accessed in accord with the invention.

FIG. 49B is a representation of data stored in tables that are accessed in accord with the invention.

FIG. 49C is a representation of data stored in tables that are accessed in accord with the invention.

FIG. 50A is a representation of data stored in tables that are accessed in accord with the invention.

FIG. 50B is a representation of data stored in tables that are accessed in accord with the invention.

FIG. 51A is a representation of data stored in tables that are accessed in accord with the invention.

FIG. 51B is a representation of data stored in tables that are accessed in accord with the invention.

FIG. 52A is a representation of data stored in tables that are accessed in accord with the invention.

FIG. 52B is a representation of data stored in tables that are accessed in accord with the invention.

FIG. 53A is a representation of data stored in tables that are accessed in accord with the invention.

FIG. 53B is a representation of data stored in tables that are accessed in accord with the invention.

FIG. 54A is a textual description of the Ai_dtree table and a representation of data stored in tables that are accessed in accord with the invention.

FIG. 54B is a representation of the data stored in tables that are accessed in accord with the invention.

FIG. 54C is a representation of the data stored in tables that are accessed in accord with the invention.

FIG. 54D is a representation of the data stored in tables that are accessed in accord with the invention.

FIG. 55A is a textual description of the Exam_codes table.

FIG. 55B is a representation of the data stored in the table that is accessed in accord with the invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to like elements throughout.

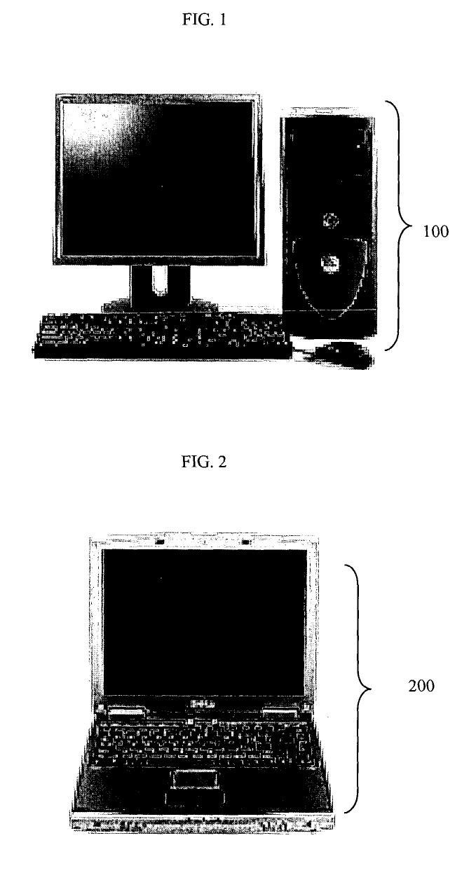

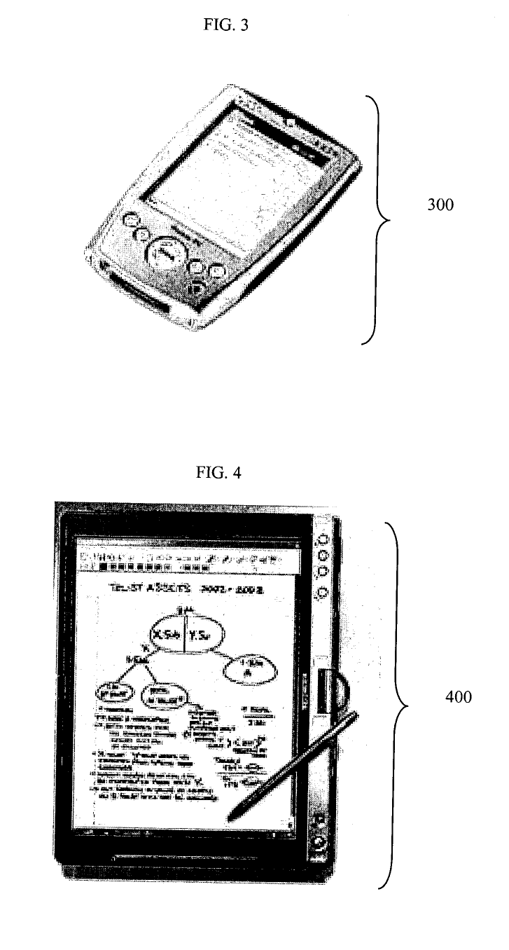

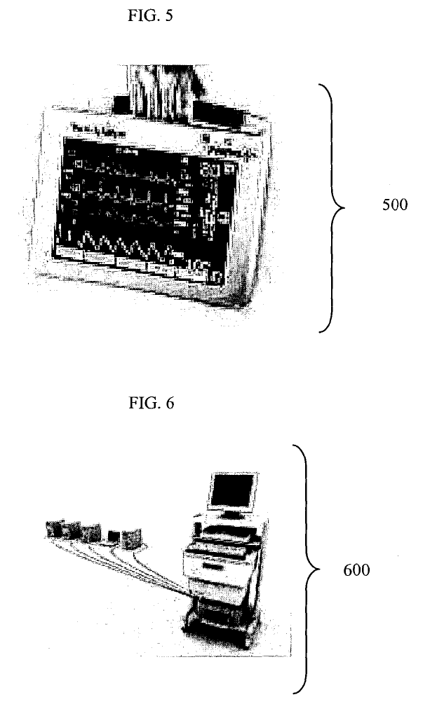

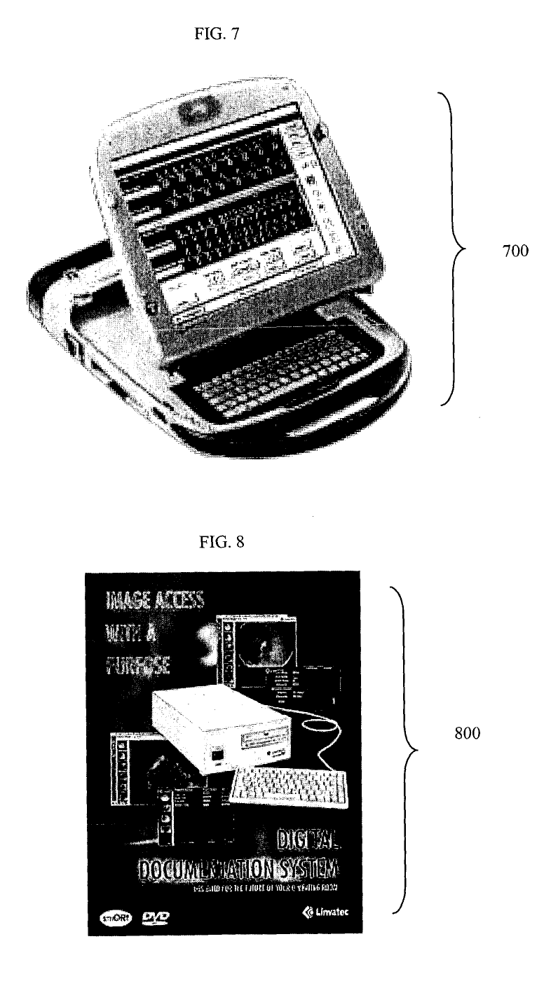

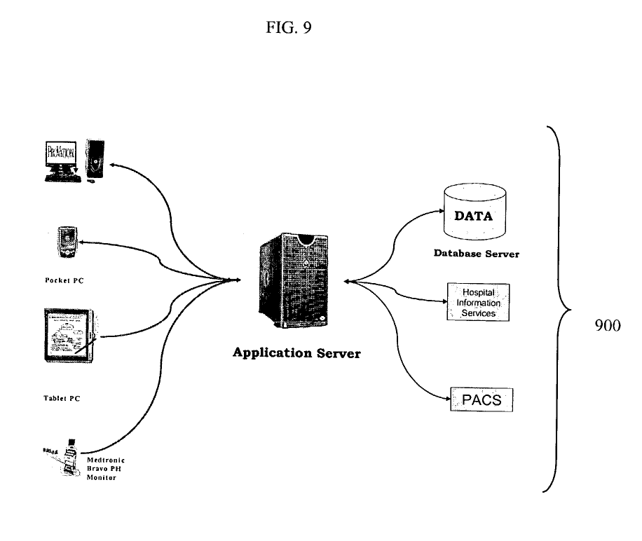

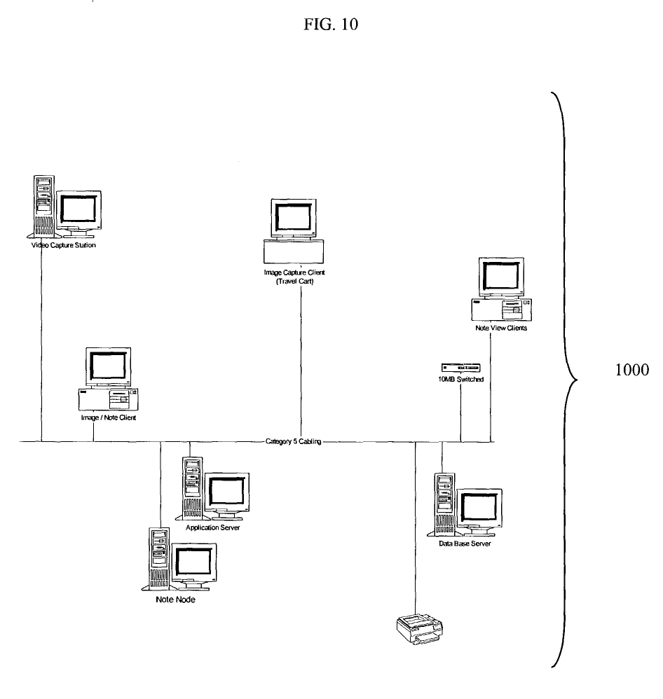

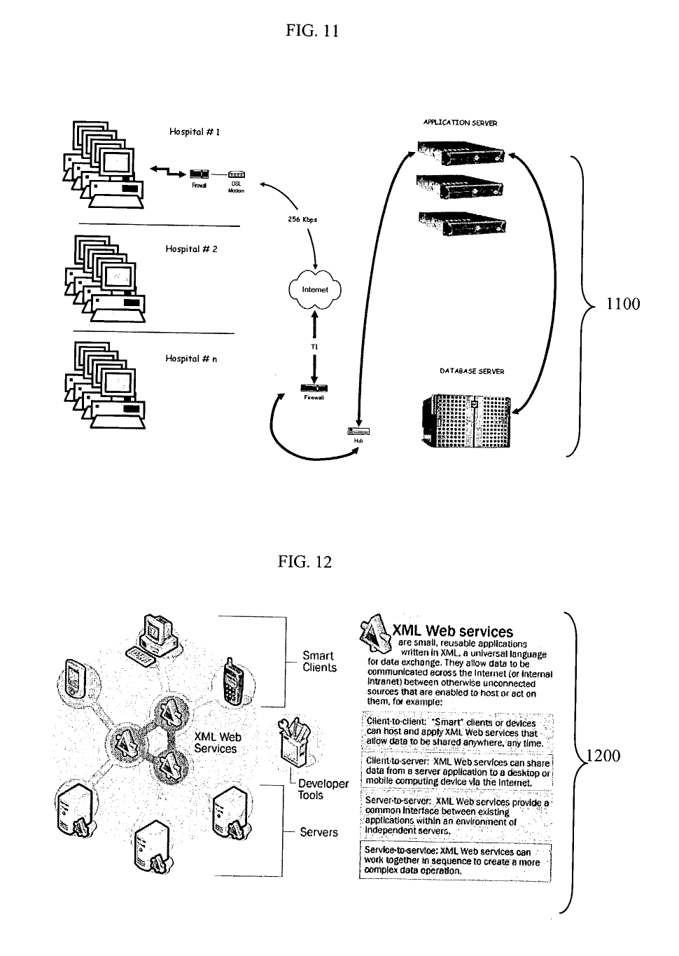

Referring to FIG. 9, the present invention includes a plurality of general purpose computing devices interconnected in networked configuration. Referring to FIG. 11, this networked configuration can be in the form of a LAN, WAN, ISDN, Internet, or wired or wireless networked configuration. Referring to FIG. 1 to FIG. 8, the general purpose computing devices can be a personal computer 100, or laptop computer 200, or Pocket PC 300, or tablet pc 400, or portable device monitor 500, or data capture computer 600, or stationary device monitor 700, or image capture device 800. Referring to FIG. 10, the general purpose computing devices communicate with a database server via standard TPC/IP network wireless or wired protocols. The database, which includes a knowledge base in the form of a plurality of medical content specialties, is managed by the database server. A plurality of printers is also included in this configuration. The computing devices may have their own local printers.

The system is written with commercially available application development and database applications. The system can be written in any programming language using commercially available database system. Referring to FIG. 12, the current system runs on Windows computers but the present invention is not limited to any specific operating systems, programming language, database vendor, or computing device.

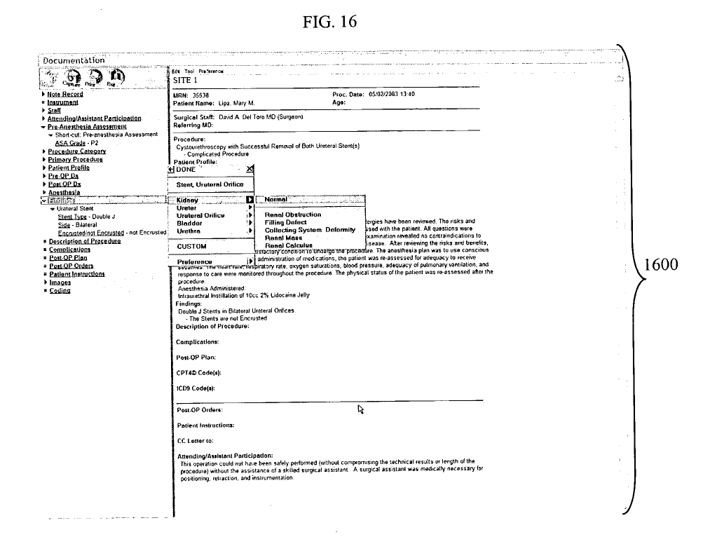

Referring to FIG. 16, a physician uses the invention by going through the anticipatory system menus to document the procedure. The system is designed so that the physician is presented with natural procedure descriptors, in a manner that the physician would expect, and in a manner in which the physician would describe the procedure. The system constructs natural procedure labels that summarize the menu selections made by the physician, places these labels into the procedure report, and constructs records in the database that are used to generate the associated CPT codes.

To maximize the value of the information maintained by the system, it is important to facilitate both information entry, to ensure that the system can access all pertinent information, and information retrieval, to ensure that the information is accessible and that such retrieved information is accurately provided to the provider for proper interpretation. Further, the physicians must have confidence that the information is accurate, secure, and fail-safe; otherwise, physicians will be reluctant to rely upon the system for maintaining medical information.

In a typical configuration, the program modules of the system are organized in a multi-tier architecture. Several computers throughout the healthcare facility are equipped with the client-side components of the system, which can access other server-side components located on other computers via the network. The client-side system components physician user interface comprises a number of screens in a computing environment that prompts the physician for input and displaying output.

While the preferred implementation for a hospital setting is a network environment, many of the system functions, including the physician interface and data management functions can be performed on a single computer.

The discussions are intended to provide a brief, general description of a suitable computing environment for the server and client computers. As noted previously, the system is implemented as a series of program modules, comprising computer executable instructions executed either on a server or client computer. Generally, program modules include routines, programs, components, and data structures that perform specific coordinated and synchronized tasks.

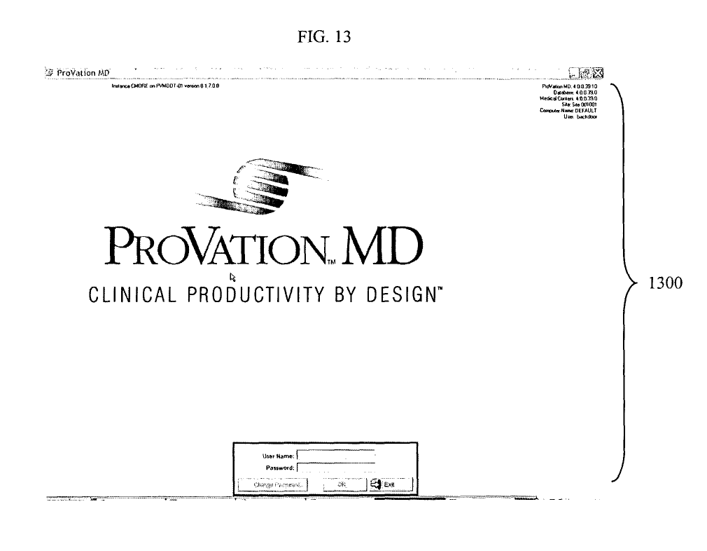

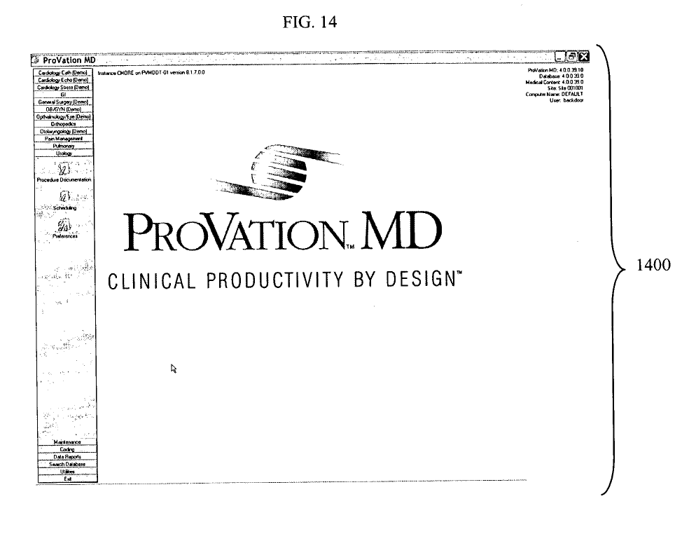

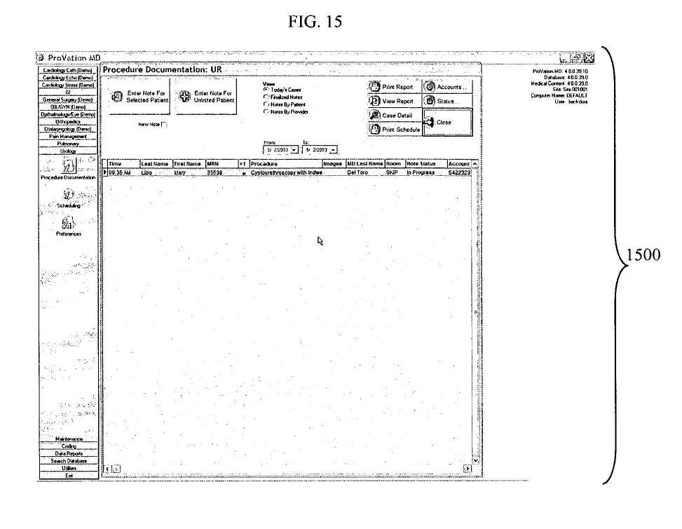

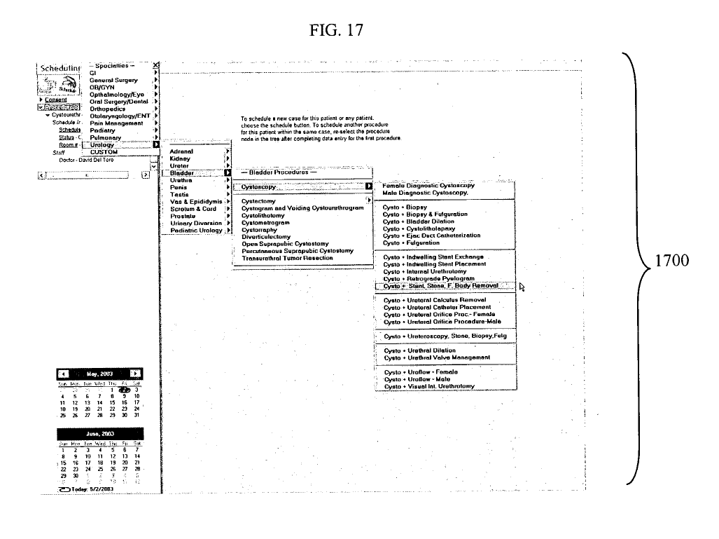

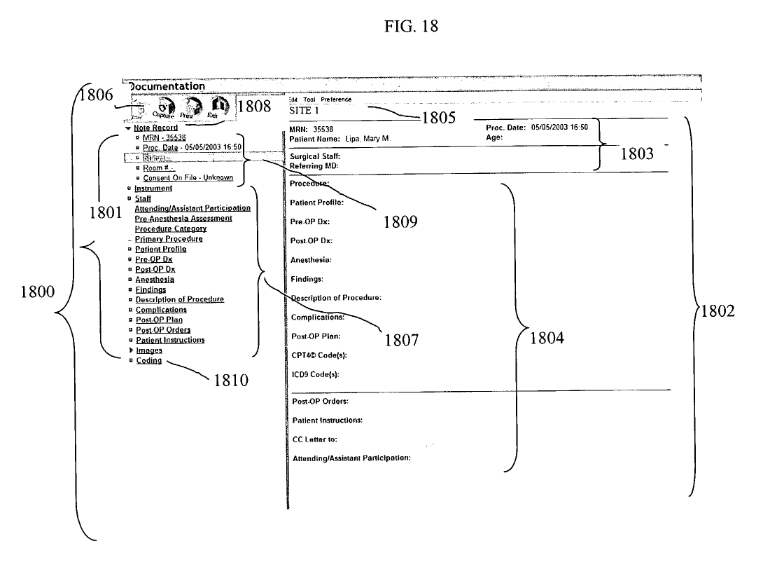

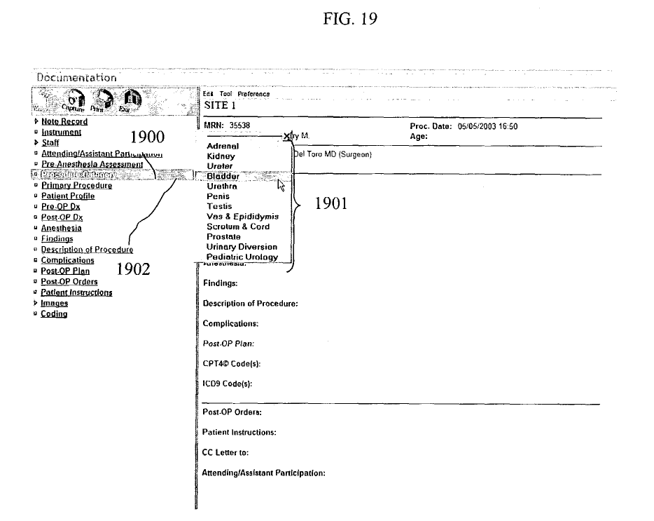

The physician logs on to the system with a user name and password 1300 (FIG. 13). After securing access to the system (FIG. 14) the physician is presented with a screen that allows them to select the specialty area for procedure documentation 1400. Referring now to FIG. 15, the physician is presented a listing of procedures that need procedure documentation 1500. The listings of procedures 1500 is typically generated by a scheduling interface or by scheduling personnel using the scheduling module 1700, see FIG. 17. The physician begins the documentation of the procedure by selecting rows of data in the listing of procedures 1500. The physician user interface then displays a screen illustrated in FIG. 18.

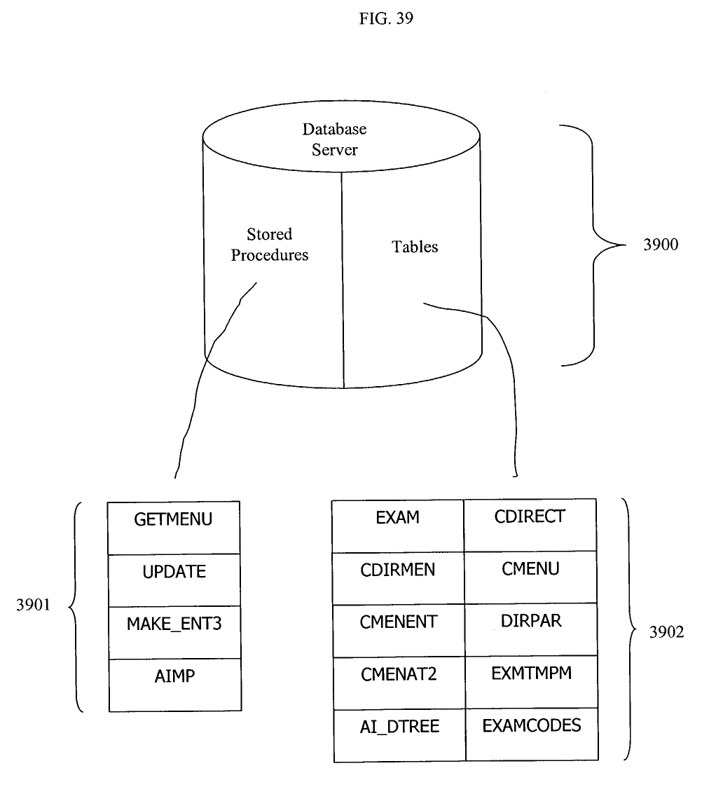

FIG. 18 is a screen shot illustrating the operation of a system program 1800, and more particularly the navigation tree and report area, according to an embodiment of the present invention. Referring now to FIG. 18, the display of the system program typically comprises a navigation tree 1801, a report area 1802, a program function icon area 1806, and a program function menu bar 1805. Referring now to FIG. 39, the system program accesses a database server 3900 that is further comprised of programming logic in the form of Structured Query Language (SQL) stored procedures 3901 and data tables 3902.

Referring to FIG. 18, the navigation tree 1801 is comprised of several nodes 1809, 1807 that represent distinct areas of report documentation. One specific node, Note Record 1808 contains demographic information about the patient that is typically entered by the nursing or front desk personnel but can be automatically populated by an interface from the hospital information system. After entering data into the sub-nodes 1809 detailed within the Note Record 1808, the data is automatically copied to the demographic subsection 1803 of the report area 1802. Additional data is entered via the navigation tree 1801 by clicking on other nodes 1807. The data entered is automatically copied to subsection 1804 of the report area 1802.

FIG. 19 is a screen shot illustrating the first step in the constructing of a natural procedure label controlled for coding. Referring now to FIG. 19, the physician navigates to or is automatically navigated to the node labeled Procedure Category 1900. After clicking on the Procedure Category 1900 node several sophisticated interactions take place between the database server's 3900 (FIG. 39) stored procedures 3901 and data tables 3902 resulting in the display of the procedure category menu 1901.

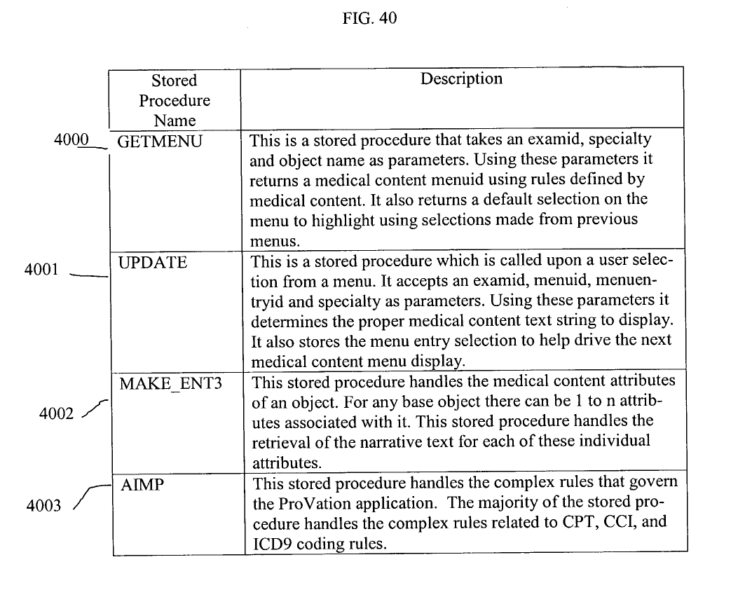

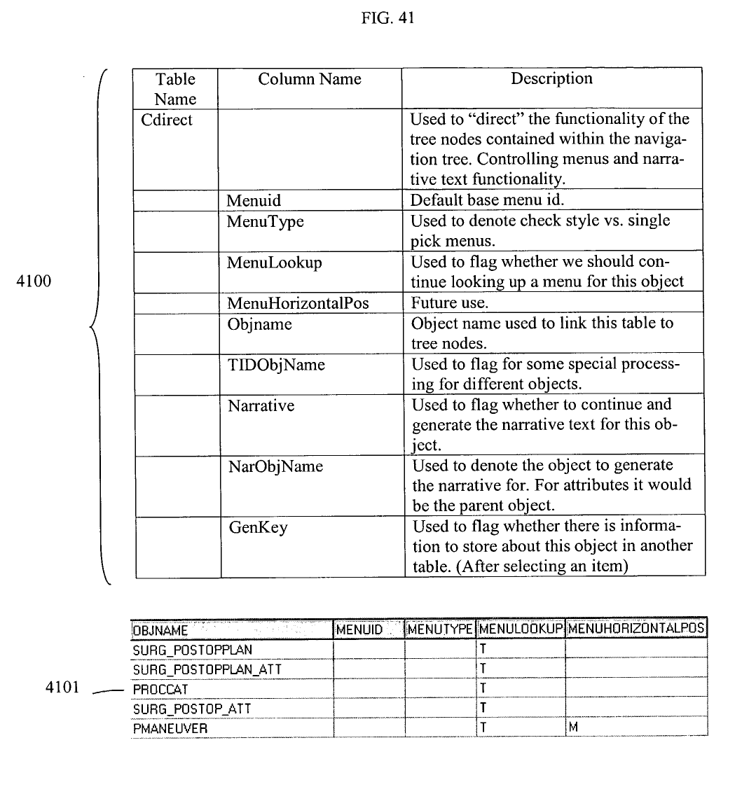

The first sophisticated interaction is with the stored procedure Getmenu 4000 (FIG. 40). Getmenu 4000 is executed and returns a data element that is used to build the procedure category menu 1901. The next operation searches through the Cdirect table 4100 (FIG. 41) looking for data that indicates that there is a procedure category menu 1901 associated with the procedure category 1900 node. A row of data 4101 (FIG. 41) is returned that satisfies the search criteria.

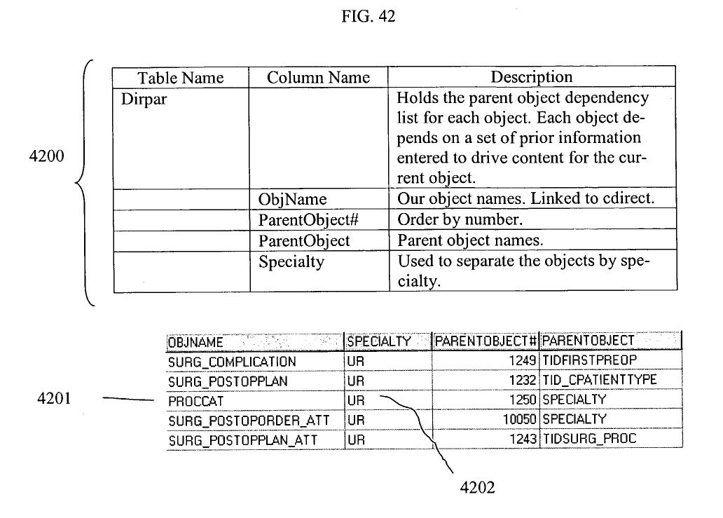

Referring now to FIG. 42, the next operation within the stored procedure GetMenu 4000 (FIG. 40) is the searching for data in the Dirpar table 4200 (FIG. 42) that couples the Procedure Category 1900 node to a specific medical specialty. A row of data 4201 (FIG. 42) is returned that satisfies the search criteria and this example contains a data element that couples the Procedure Category 1900 node to the Urology specialty 4202.

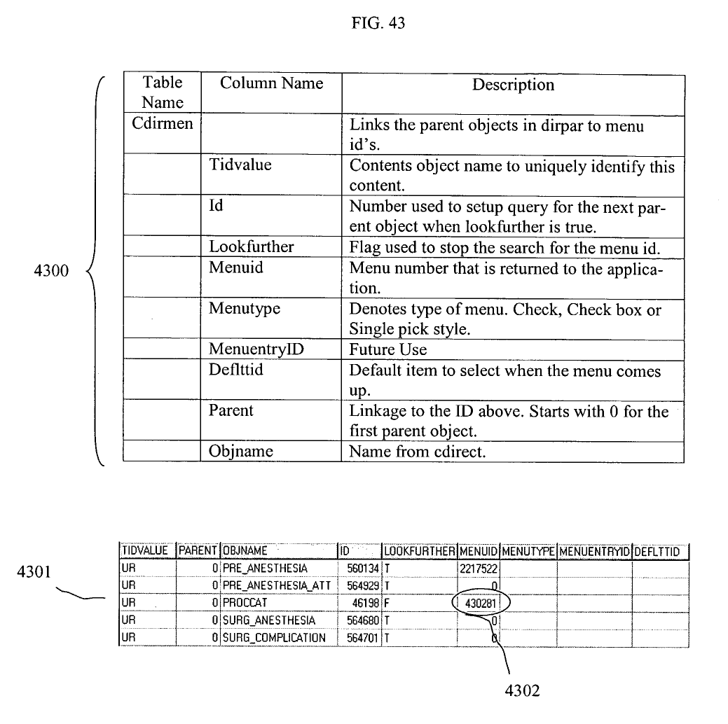

Referring now to FIG. 43, the next operation within the stored procedure GetMenu 4000 searches for data in the Cdirmen table 4300 (FIG. 43) that contains a menuid 4302 that is used to build the procedure category menu 1901 for the specialty ‘UR’ 4202. A row of data 4301 is located that contains a menuid 4302 with a value of ‘430281’.

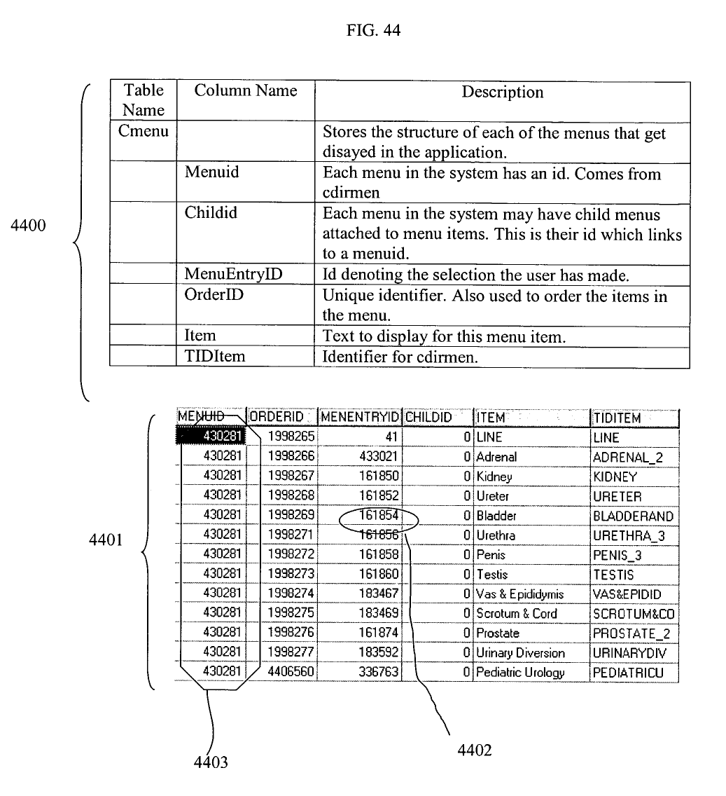

Referring now to FIG. 44, the Cmenu table 4400 is searched for rows of data that match the menuid value 4302 (FIG. 43) with the menuid value 4403 (FIG. 44) in the Cmenu table 4400 (FIG. 44). Several rows of data 4401 are returned that are used by the system to build the procedure category menu 1901.

Referring now to FIG. 19, the physician is presented with a controlled list of available procedure categories, the procedure category menu 1901 which was derived from the data 4401 retrieved from the Cmenu table 4400.

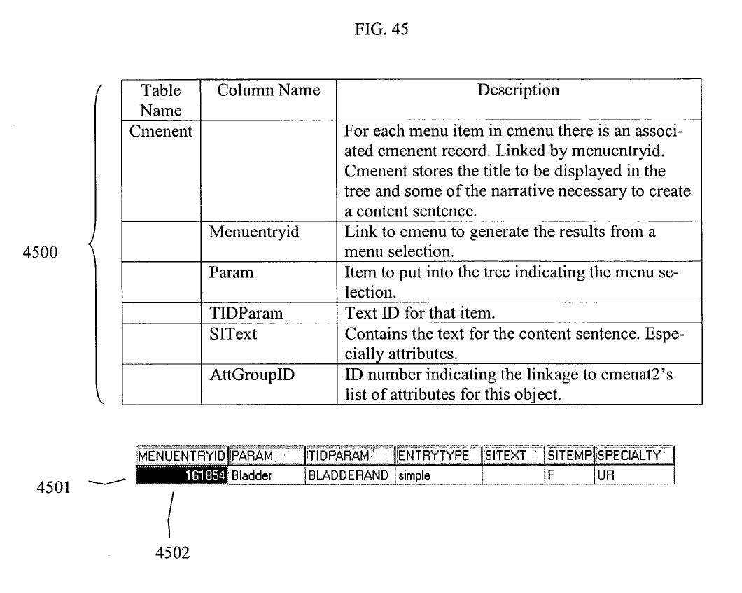

Referring to FIG. 19, in this specific example, the physician has decided to document a procedure located within the procedure category of Bladder and clicks on the menu selection labeled Bladder 1902. Several system operations occur with the stored procedure Update 4001 (FIG. 40). The first operation searches through the Cmenent table 4500 (FIG. 45) for a row of data that has a data element that matches the value, ‘161854’, of the data element 4402 (FIG. 44). A row of data 4501 (FIG. 45) is returned that has a menuentryid 4502, containing the value, ‘161854’, which matches the value contained in the data element 4402. The first step in the constructing of a natural procedure label controlled for coding is complete; the physician has selected the procedure category.

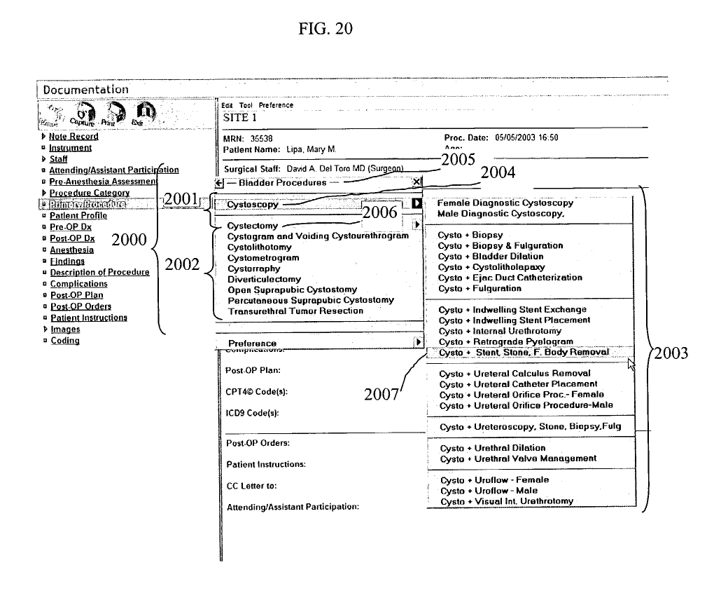

The physician is next presented with a screen illustrated in FIG. 20 after several sophisticated interactions between the database server's 3900 stored procedures 3901 and data tables 3902 are completed. These interactions retrieve data from the database that is utilized to present menus of available procedure types for the ‘Bladder’ procedure category.

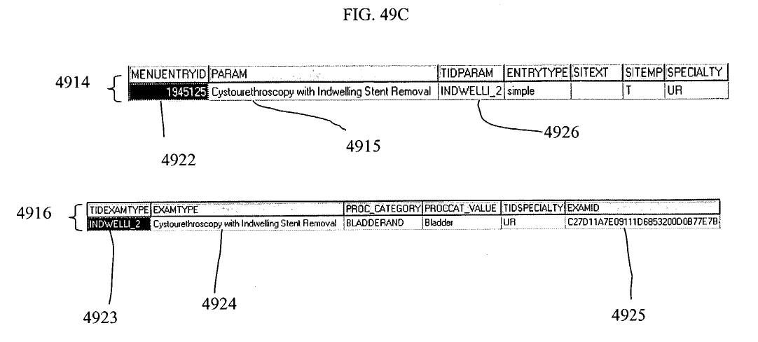

The first sophisticated interaction is with the stored procedure Getmenu 4000 (FIG. 40). Getmenu is executed and returns a data element that is used to build the base menu 2000 (FIG. 20) of procedure types 2001 and procedures 2002. The first operation searches through the Cdirect table 4100 (FIG. 41) looking for data values which indicate that there are procedure types 2001 and procedures 2002 associated with the selected procedure category 2005. Referring to FIG. 49A, a row of data 4900 is returned that satisfies the search criteria.

The next operation within the stored procedure GetMenu 4000 is the searching for data in the Dirpar table 4200 (FIG. 42) that links the procedure types 2001 and procedures 2002 to a specific medical specialty. Referring to FIG. 49A, a row of data 4901 is returned that satisfies the search criteria and in this example contains a data element that couples the procedure types 2001 and procedures 2002 to the Urology specialty, ‘UR’, 4902 (FIG. 49A).

The next operation within the stored procedure GetMenu 4000 searches for data in the Cdirmen table 4300 (FIG. 43) that matches specialty value ‘UR’ 4902 and Objname 4901. Referring to FIG. 49A, a row of data is retrieved that meets the criteria, the specialty value 4902 matches the Tidvalue 4919 and the Objname 4901 matches the Objname 4917. The row of data contains an ID 4904 with a data value of ‘564744’ that is used to find the base menu 2000 for the procedure category of bladder procedures 2005 (FIG. 20).

Next, the Cmenu table 4400 (FIG. 44) is searched for the rows of data that match the data element 4904 (FIG. 49A) for the procedure category of bladder procedures 2005. Referring to FIG. 49A, a row of data 4905 is returned that matches the ID 4904 value with the Parent 4918 value. This row of data contains the data element 4906 which has a value of ‘159872’ which is used to retrieve the next set of menuids.

Referring to FIG. 49A, the data element 4906 is used to find all of the procedure types and procedures 4907 (FIG. 49B) which are displayed in the base menu 2000 and the child menu of procedures 2003. The base menu 2000 is created by locating all of the data 4908 in the cmenu table 4400 that have a menuid that matches the value of the data element 4906 (FIG. 49A). As the stored procedure GetMenu 4000 processes the retrieved data it determines if additional menus are needed by checking the values stored in the Childid column 4920 of Cmenu table 4400. Additional data 4909 are retrieved that match the value in the Childid 4911 with the value in the Menuids 4921. This data is used to create the child menu of procedures 2003 for the procedure type 2004 of Cystoscopy. The data element 4912 is used to locate the data 4910 which are used to create the child menu of procedures for the procedure type 2006 of Cystectomy.

The interactions that retrieve data from the database are complete and the physician is presented with the menus of available procedure types for the ‘Bladder’ procedure category. FIG. 20 is a screen shot illustrating the menus retrieved from the database. The screen shot represents a base menu 2000 of procedure types 2001 and procedures 2002, a child menu of procedures 2003 for the procedure type 2004 of Cystoscopy for the procedure category of Bladder Procedures 2005. The child menu of procedures 2003 is displayed when the cursor “flies over” the procedure type of Cystoscopy 2004 and a different child menu of procedures is displayed but not illustrated when the cursor “flies over” the procedure type of Cystectomy 2006.

In this specific example, the physician is documenting a procedure located within the procedure category of Bladder Procedures 2005, the procedure type 2004 of Cystoscopy, and clicks on the menu selection for the procedure Cysto+ Stent, Stone, F. Body Removal 2007. After clicking on the procedure Cysto+ Stent, Stone, F. Body Removal 2007, several system operations occur with the stored procedure Update 4001. The first operation searches through the Cmenent table 4500 for data that has a Menuentryid value 4922 that matches the data element 4913 in FIG. 49B. A row of data 4914 is returned which contains data that is updated in the exam table 4600.

Referring now to FIG. 49C, the next operation within the stored procedure Update 4001 is the updating of data in the exam table 4600. The exam table 4600 Tidexamtype value 4923 is updated with the Tidparam value 4926 and the Examtype value 4924 is updated with the Param value 4915 for the procedure record with a specific examid 4925. The second step in the constructing of a natural procedure label controlled for coding is complete. The physician has selected the procedure that they will be documenting and the system next needs to prompt the physician for additional data that will control the natural procedure label for coding.

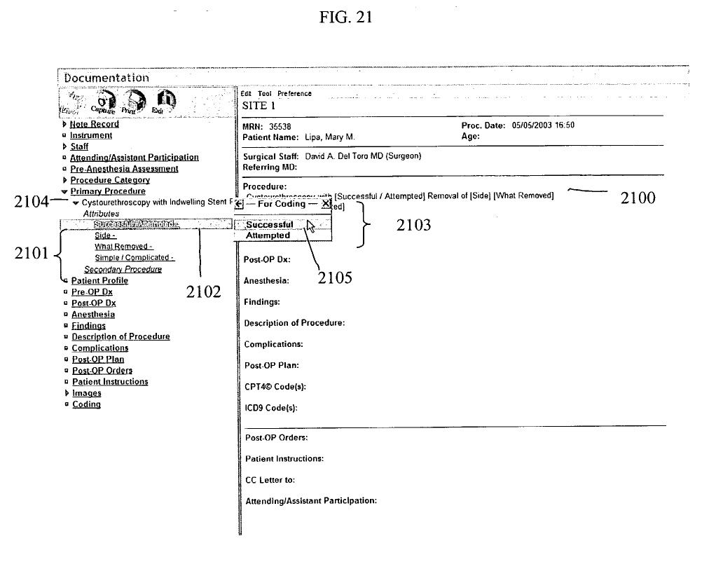

A screen shot illustrating the next step in the constructing of a natural procedure label controlled for coding in shown in FIG. 21. The physician is presented with the screen illustrated in FIG. 21, after several sophisticated interactions between the database server's 3900 stored procedures 3901 and data tables 3902. These sophisticated interactions retrieve data from the database that builds that attribute menu 2103.

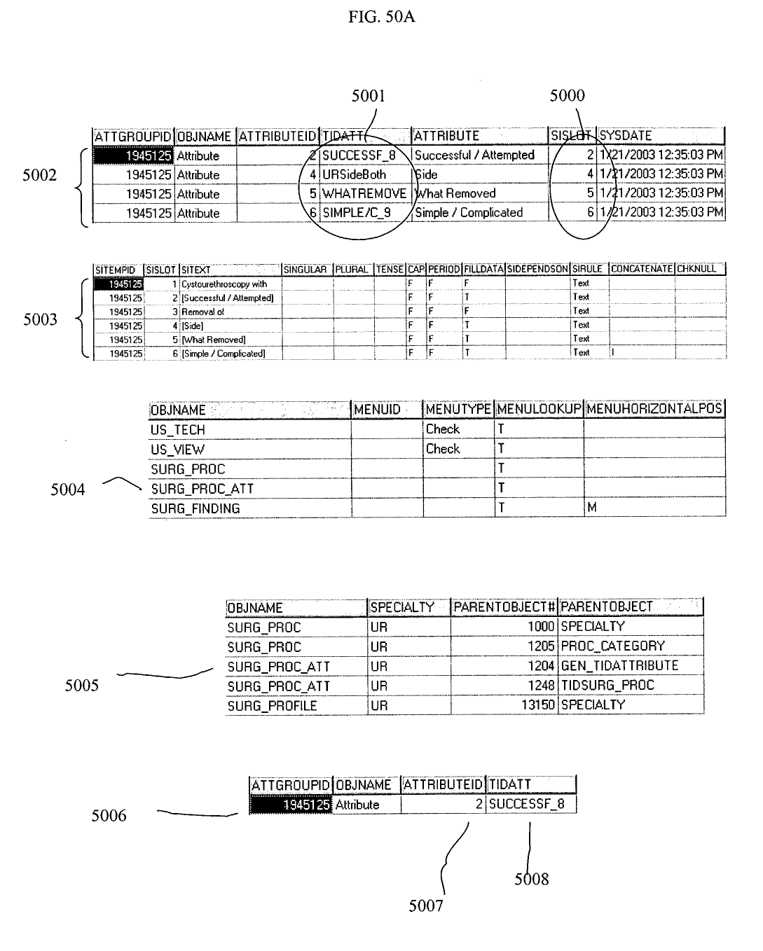

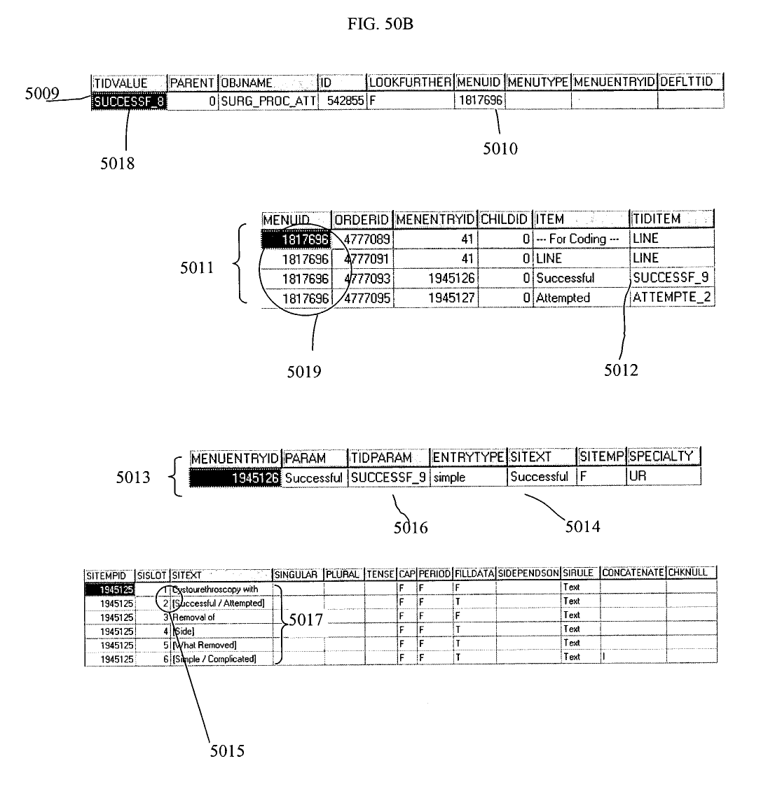

The first sophisticated system operation constructs the attribute tree 2101 and the structured uncompleted natural procedure label 2100. The stored procedure make_ent3 4002 (FIG. 40) searches through the cmenat2 table 4700 (FIG. 47) looking for data that matches the value 4922 (FIG. 49C) which link the common procedure name 2104 to an attribute tree 2101. Referring to FIG. 50A, several rows of data 5002 are returned and are used to construct the attribute tree 2101.

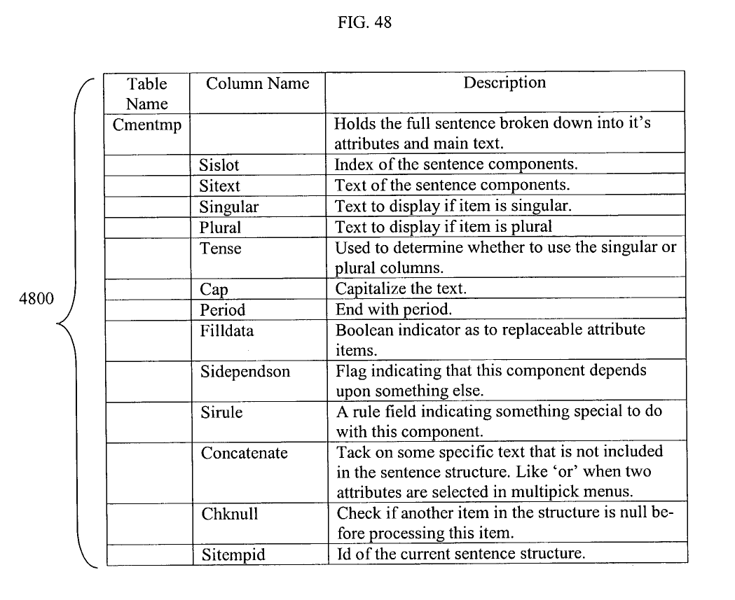

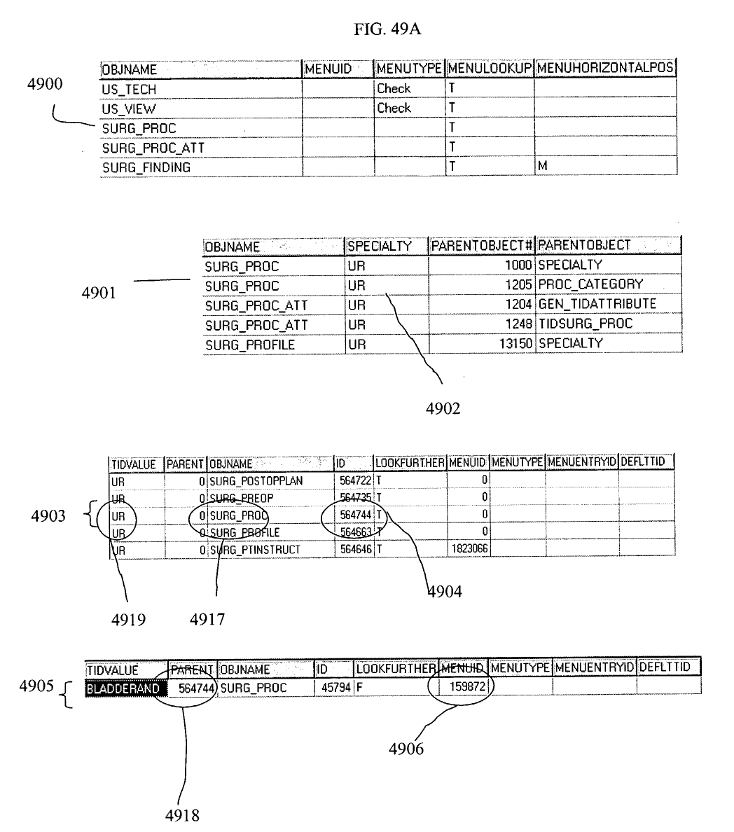

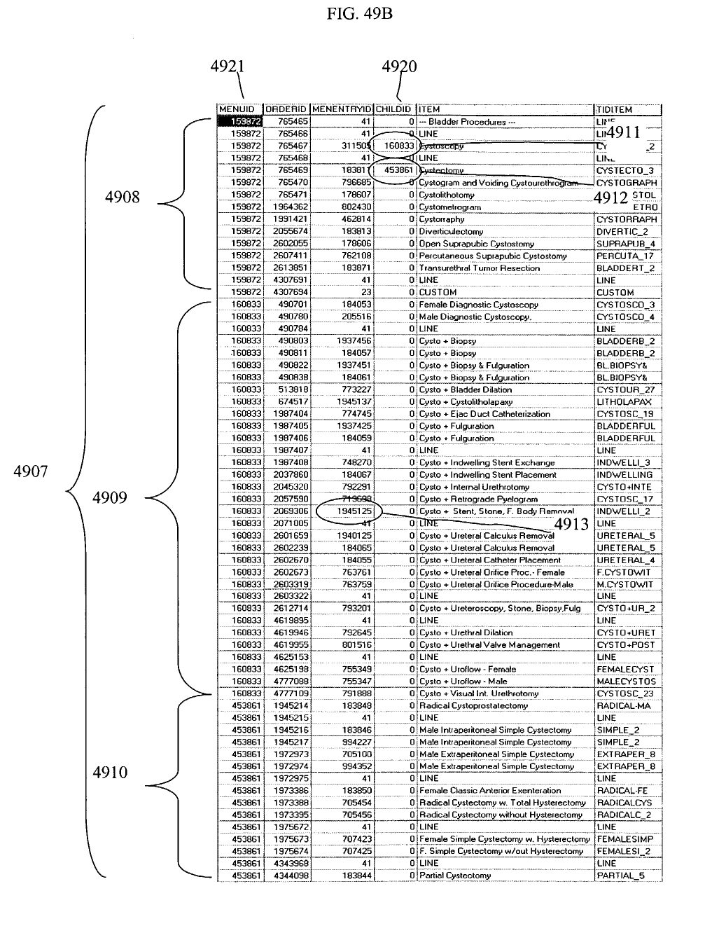

The next operation within the stored procedure make_ent3 4002 (FIG. 40) searches through the cmentmp table 4800 (FIG. 48) looking for data that matches the value 4922 (FIG. 49) which couples the common procedure name 2104 (FIG. 21) to the structured uncompleted natural procedure label 2100. Referring to FIG. 50A, several rows of data 5003 are returned and are used to construct the structured uncompleted natural procedure label 2100.

Next, several system operations occur within the stored procedure Getmenu 4000 (FIG. 40). The first operation searches through the Cdirect table 4100 (FIG. 41) looking for data that indicates that there is an attribute menu 2103 (FIG. 21) for the attribute node 2102 from the attribute tree 2101. Referring to FIG. 50A, a row of data 5004 is returned that satisfies the search criteria.

The next operation within the stored procedure GetMenu 4000 (FIG. 40) is the searching for data in the Dirpar table 4200 (FIG. 42) that links the common procedure name for a specific medical specialty to the attribute menu 2103 (FIG. 21). Referring to FIG. 50A, a row of data 5005 is returned that indicates that an attribute menu 2103 needs to be constructed. The cmenat2 table 4700 (FIG. 47) is searched looking for data that matches the value 4922 (FIG. 49). A row of data 5006 is returned that satisfies the search criteria and contains a data value 5008 which is used to construct the attribute menu 2103 (FIG. 21).

The next operation within the stored procedure GetMenu 4000 (FIG. 40) is the searching for data in the Cdirmen table 4300 (FIG. 43). Referring to FIG. 50B, a row of data 5009 is returned that has the Tidvalue value 5018 matching the TidAtt value 5008. The row of data contains a menuid 5010 with a data value of ‘1817696’ which is used to find the menu items which are used to construct the attribute menu 2103 (FIG. 21). Next, the Cmenu table 4400 (FIG. 44) is searched for the rows of data that match the data element 5010. Referring to FIG. 50B, several rows of data 5011 are returned that match the menuid value 5019 with the menuid value 5010 that are used to build the attribute menu 2103 (FIG. 21).

The data needed to form the structured uncompleted natural procedure label has been retrieved from the database and FIG. 21 is a screen shot illustrating the next step in the constructing of a natural procedure label controlled for coding. Referring now to FIG. 21, the screen shot represents the structured uncompleted natural procedure label 2100, the common procedure name 2104, the attribute tree 2101, and the attribute menu 2103 for the first required controlled attribute for the structured uncompleted natural procedure label 2100. In this example, the physician was ‘Successful’ with this aspect of the procedure and clicks on the menu item 2105 in the attribute menu 2103 documenting ‘Successful’.

After clicking on the menu item 2105, the Cmenent table 4500 (FIG. 45) is searched for the rows of data that match the data element 5012 (FIG. 50B). In this example, the system is retrieving data that will dynamically update the structured uncompleted natural procedure label with the menu item's 2105 textual representation. Referring to FIG. 50B, a row of data 5013 is returned. The structured uncompleted natural procedure label 2100 is then reconstructed by concatenating the Sitext 5017 data values and inserting into this concatenation specific replacement text 5014 into the Sislot location that is the match of 5007 and 5015. In this example, the structured uncompleted natural procedure label is modified and the word ‘Successful’ 5014 replaces the placeholder text ‘[Successful/Attempted]’ that had previously been displayed in the structured uncompleted natural procedure label 2100. The next step in the constructing of the structured uncompleted natural procedure label controlled for coding is complete. The system then prompts the physician for additional data that will control the natural procedure label for coding.

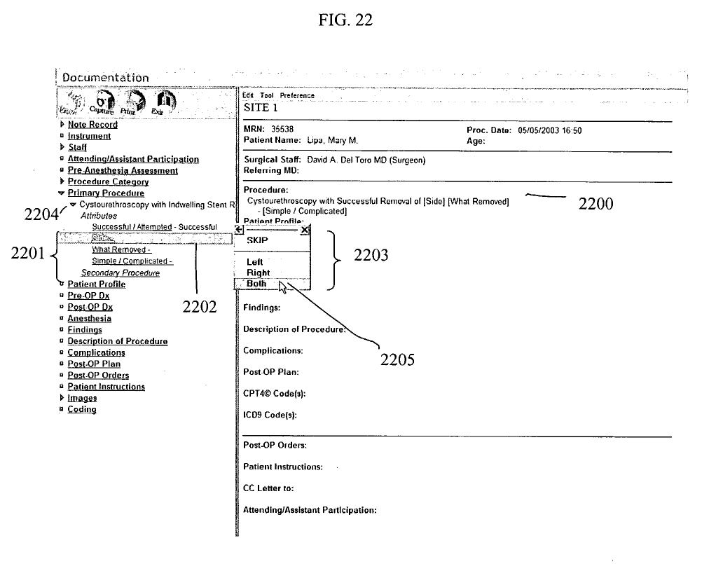

The physician is next presented with the screen illustrated in FIG. 22 after several sophisticated interactions take place between the database server's 3900 (FIG. 39) stored procedures 3901 and data tables 3902. FIG. 22 illustrates the modified structured uncompleted natural procedure label 2200 with an attribute menu 2203 prompting the physician for their next menu selection.

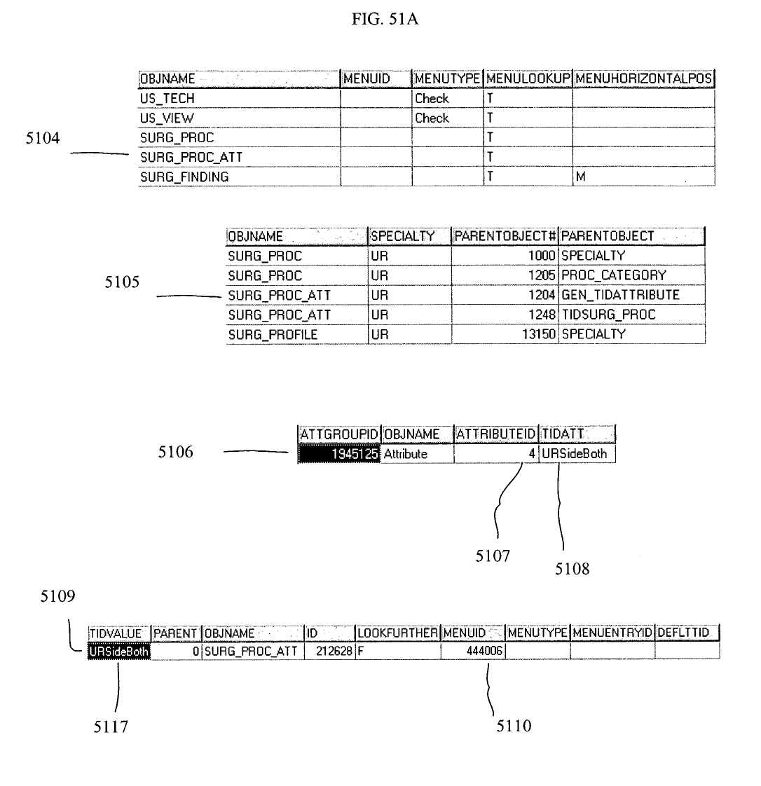

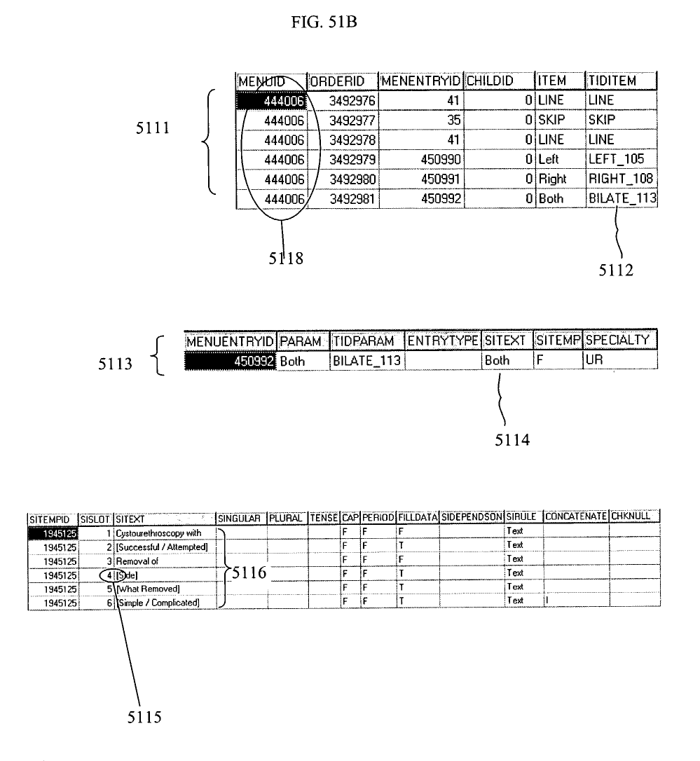

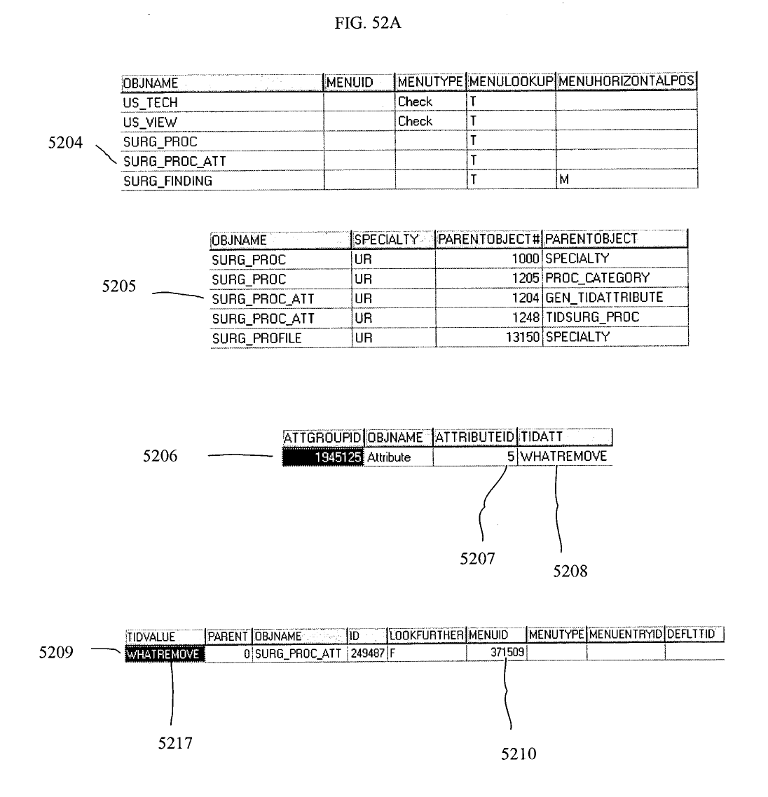

The first sophisticated interactions occur within the stored procedure Getmenu 4000 (FIG. 40), the system searches through the Cdirect table 4100 (FIG. 41) looking for data that indicates that there is an attribute menu 2203 (FIG. 22) for the attribute node 2202 from the attribute tree 2201. Referring to FIG. 51A, a row of data 5104 is returned that satisfies the search criteria.

The next operation within the stored procedure GetMenu 4000 is the searching for data in the Dirpar table 4200 (FIG. 42) that links the common procedure name for a specific medical specialty to the attribute menu 2203. Referring to FIG. 51A, a row of data 5105 is returned that indicates that an attribute menu 2203 needs to be constructed. The cmenat2 table 4700 (FIG. 47) is searched looking for data that matches the value 4922 (FIG. 49). A row of data 5106 (FIG. 51A) is returned that satisfies the search criteria and contains a data value 5108 which is used to construct the attribute menu 2203.

The next operation within the stored procedure GetMenu 4000 is the searching for data in the Cdirmen table 4300. Referring to FIG. 51A, a row of data 5109 is returned that has the Tidvalue 5117 matching the Tidatt value 5108. The row of data contains a menuid 5110 that is used to find the menu items which are used to construct the attribute menu 2203. Next, the Cmenu table 4400 (FIG. 44) is searched for the rows of data that match the data element 5110. Referring to FIG. 51B, several rows of data 5111 are returned that match the menuid value 5118 with the menuid value 5110 that are used to build the attribute menu 2203.

The data needed to form the structured uncompleted natural procedure label has been retrieved from the database and FIG. 22 is a screen shot illustrating the next step in the constructing of a natural procedure label controlled for coding. Referring now to FIG. 22, the screen shot represents the structured uncompleted natural procedure label 2200, the common procedure name 2204, the attribute tree 2201, and the attribute menu 2203 for the next required controlled attribute for the structured uncompleted natural procedure label 2200. In this example, the physician was ‘Successful’ with the removal of ‘Both’ and clicks on the menu item 2205 in the attribute menu 2203 documenting ‘Both’.

After clicking on the menu item 2205, the Cmenent table 4500 (FIG. 45) is searched for the rows of data that match the data element 5112 (FIG. 51B). In this example, the system is retrieving data that will dynamically update the structured uncompleted natural procedure label with the menu item's 2205 textual representation. Referring to FIG. 51B, a row of data 5113 is returned. The structured uncompleted natural procedure label 2200 is then reconstructed by concatenating the Sitext 5116 and inserting specific replacement text 5014 (FIG. 50) into the Sislot location that is the match of 5007 and 5015 and inserting into this concatenation specific replacement text 5114 into the Sislot location that is the match of 5107 and 5115 (FIG. 51). In this example, the structured uncompleted natural procedure label is modified and the word ‘Both’ 5114 replaced the placeholder text ‘[Side]’ that had previously been displayed in the structured uncompleted natural procedure label 2200. The next step in the constructing of the structured uncompleted natural procedure label controlled for coding is complete. The system then prompts the physician for additional data that will control the natural procedure label for coding.

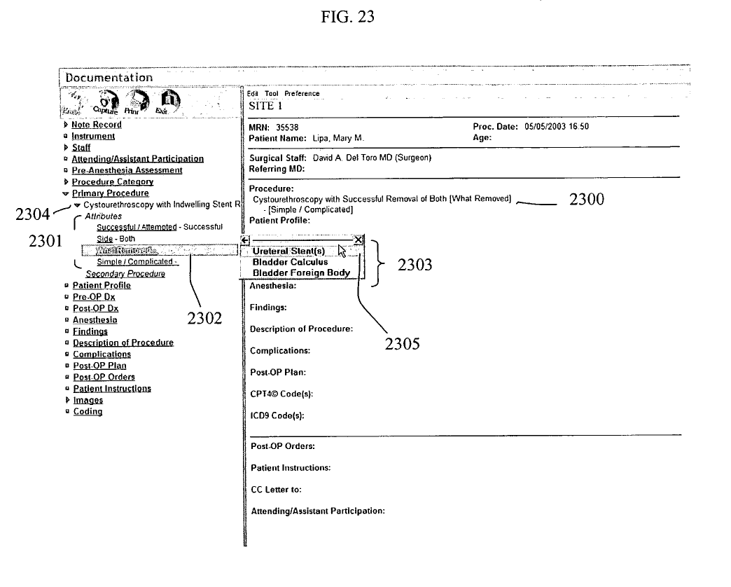

The physician is next presented with the screen illustrated in FIG. 23 after several sophisticated interactions take place between the database server's 3900 stored procedures 3901 and data tables 3902. FIG. 23 illustrates the modified structured uncompleted natural procedure label 2300 with an attribute menu 2303 prompting the physician for their next menu selection.

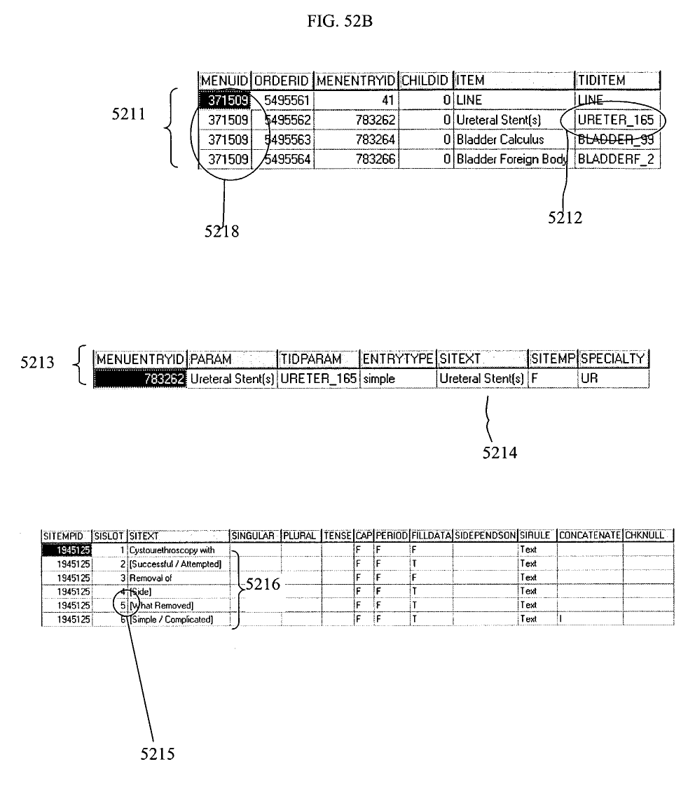

The first sophisticated interactions occur within the stored procedure Getmenu 4000 (FIG. 40), the system searches through the Cdirect table 4100 (FIG. 41) looking for data that indicates that there is an attribute menu 2303 (FIG. 23) for the attribute node 2302 from the attribute tree 2301. Referring to FIG. 52A, a row of data 5204 is returned that satisfies the search criteria.

The next operation within the stored procedure GetMenu 4000 is the searching for data in the Dirpar table 4200 (FIG. 42) that links the common procedure name for a specific medical specialty to the attribute menu 2303. Referring to FIG. 52A, a row of data 5205 is returned that indicates that an attribute menu 2303 needs to be constructed. The cmenat2 table 4700 (FIG. 47) is searched looking for data that matches the value 4922 (FIG. 49). A row of data 5206 (FIG. 52A) is returned that satisfies the search criteria and contains a data value 5208 which is used to construct the attribute menu 2303.

The next operation within the stored procedure GetMenu 4000 is the searching for data in the Cdirmen table 4300. Referring to FIG. 52A, a row of data 5209 is returned that has the Tidvalue value 5217 matching the TidAtt value 5208. The row of data contains a menuid 5210 that is used to find the menu items which are used to construct the attribute menu 2303. Next, the Cmenu table 4400 (FIG. 44) is searched for the rows of data that match the data element 5210. Referring to FIG. 52B, several rows of data 5211 are returned that match the menuid value 5218 with the menuid value 5210 that are used to build the attribute menu 2303.

The data needed to form the structured uncompleted natural procedure label has been retrieved from the database and FIG. 23 is a screen shot illustrating the next step in the constructing of a natural procedure label controlled for coding. Referring now to FIG. 23, the screen shot represents the structured uncompleted natural procedure label 2300, the common procedure name 2304, the attribute tree 2301, and the attribute menu 2303 for the next required controlled attribute for the structured uncompleted natural procedure label 2300. In this example, the physician was ‘Successful’ with the removal of ‘Both’ ‘Ureteral Stent(s)’ and clicks on the menu item 2305 in the attribute menu 2303 documenting ‘Ureteral Stent(s)’.

After clicking on the menu item 2305, the Cmenent table 4500 (FIG. 45) is searched for the rows of data that match the data element 5212 (FIG. 52B). In this example, the system is retrieving data that will dynamically update the structured uncompleted natural procedure label with the menu item's 2305 textual representation. Referring to FIG. 52B, a row of data 5213 is returned. The structured uncompleted natural procedure label 2300 is then reconstructed by concatenating the Sitext 5216 and inserting specific replacement text 5014 (FIG. 50) into the Sislot location that is the match of 5007 and 5015 and inserting into this concatenation specific replacement text 5114 into the Sislot location that is the match of 5107 and 5115 (FIG. 51) and inserting into this concatenation specific replacement text 5214 into the Sislot that is the match of 5207 and 5215 (FIG. 52). In this example, the structured uncompleted natural procedure label is modified and the word ‘Ureteral Stent(s)’ 5214 replaced the placeholder text ‘[What Removed]’ that had previously been displayed in the structured uncompleted natural procedure label 2300. The next step in the constructing of the structured uncompleted natural procedure label controlled for coding is complete. The system then prompts the physician for additional data that will control the natural procedure label for coding.

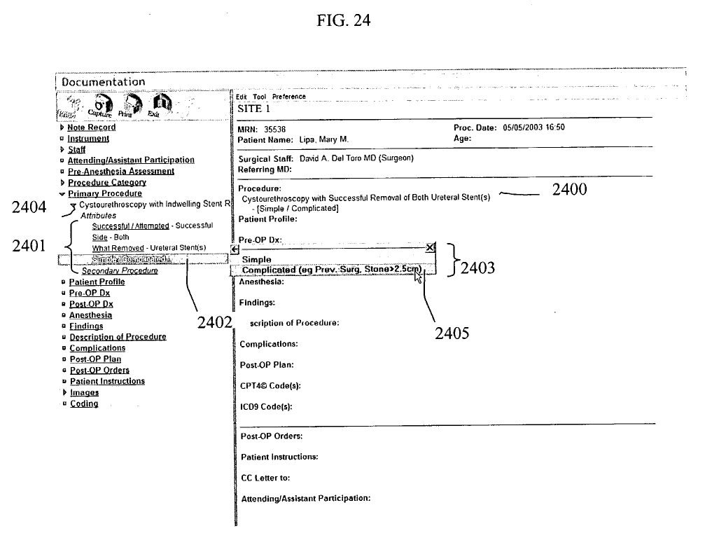

The physician is next presented with the screen illustrated in FIG. 24 after several sophisticated interactions take place between the database server's 3900 stored procedures 3901 and data tables 3902. FIG. 24 illustrates the modified structured uncompleted natural procedure label 2400 with an attribute menu 2403 prompting the physician for their next menu selection.

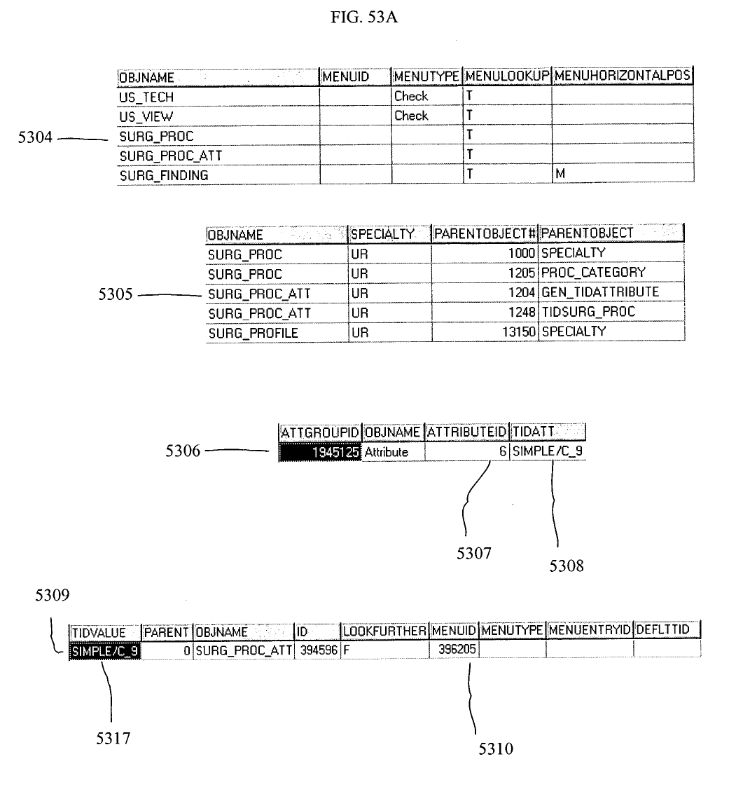

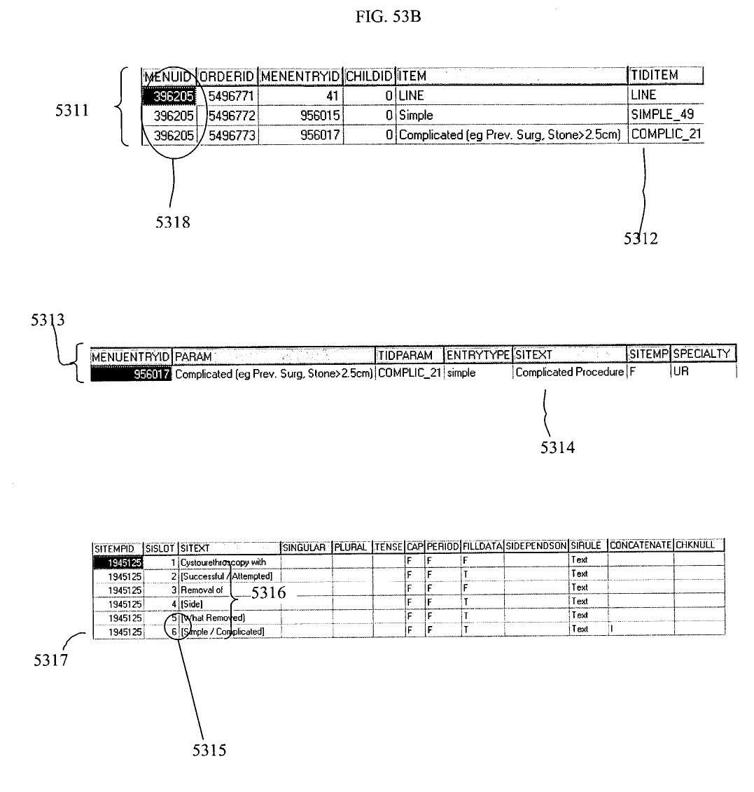

The first sophisticated interaction occur within the stored procedure Getmenu 4000 (FIG. 40), the system searches through the Cdirect table 4100 (FIG. 41) looking for data that indicates that there is an attribute menu 2403 for the attribute node 2402 from the attribute tree 2401. Referring to FIG. 53A, a row of data 5304 is returned that satisfies the search criteria.

The next operation within the stored procedure GetMenu 4000 is the searching for data in the Dirpar table 4200 (FIG. 42) that links the common procedure name for a specific medical specialty to the attribute menu 2403. Referring to FIG. 53A, a row of data 5305 is returned that indicates that an attribute menu 2403 needs to be constructed. The cmenat2 table 4700 (FIG. 47) is searched looking for data that matches the value 4922 (FIG. 49). A row of data 5306 (FIG. 53A) is returned that satisfies the search criteria and contains a data value 5308 which is used to construct the attribute menu 2403.

The next operation within the stored procedure GetMenu 4000 is the searching for data in the Cdirmen table 4300 (FIG. 43). Referring to FIG. 53A, a row of data 5309 is returned that has the Tidvalue value 5317 matching the Tidatt value 5308. The row of data contains a menuid 5310 that is used to find the menu items which are used to construct the attribute menu 2403. Next, the Cmenu table 4400 (FIG. 44) is searched for the rows of data that match the data element 5310. Referring to FIG. 53B, several rows of data 5311 are returned that match the menuid value 5018 with the menuid value 5010 that are used to build the attribute menu 2403.

The data needed to form the structured uncompleted natural procedure label has been retrieved from the database and FIG. 24 is a screen shot illustrating the next step in the constructing of a natural procedure label controlled for coding. Referring now to FIG. 24, the screen shot represents the structured uncompleted natural procedure label 2400, the common procedure name 2404, the attribute tree 2401, and the attribute menu 2403 for the next required controlled attribute for the structured uncompleted natural procedure label 2400. In this example, the physician was ‘Successful’ with the removal of ‘Both’ ‘Ureteral Stent(s)’ for a ‘Complicated’ procedure and clicks on the menu item 2405 in the attribute menu 2403 documenting ‘Complicated (eg Prev. Surg, Stone>2.5 cm)’.

After clicking on the menu item 2405, the Cmenent table 4500 (FIG. 45) is searched for the rows of data that match the data element 5312 (FIG. 53B). In this example, the system is retrieving data that will dynamically update the structured uncompleted natural procedure label with the menu item's 2405 textual representation. Referring to FIG. 53A, a row of data 5313 is returned. The structured uncompleted natural procedure label 2400 is then reconstructed by concatenating the Sitext 5316 and inserting specific replacement text 5014 (FIG. 50) into the Sislot location that is the match of 5007 and 5015 and inserting into this concatenation specific replacement text 5114 into the Sislot location that is the match of 5107 and 5115 (FIG. 51) and inserting into this concatenation specific replacement text 5214 into the Sislot that is the match of 5207 and 5215 (FIG. 52) and inserting into this concatenation specific replacement text 5314 into the Sislot location that is the match of 5307 and 5315 (FIG. 53). In this example, the structured uncompleted natural procedure label is modified and the word ‘Complicated Procedure’ 5314 replaced the placeholder text ‘[Simple/Complicated]’ that had previously been displayed in the structured uncompleted natural procedure label 2400. The system executes logic that determines that there are no more remaining attribute menus for this procedure type and system control moves to the next node on the navigation tree 2401. The last step in the constructing of the natural procedure label controlled for coding is complete.

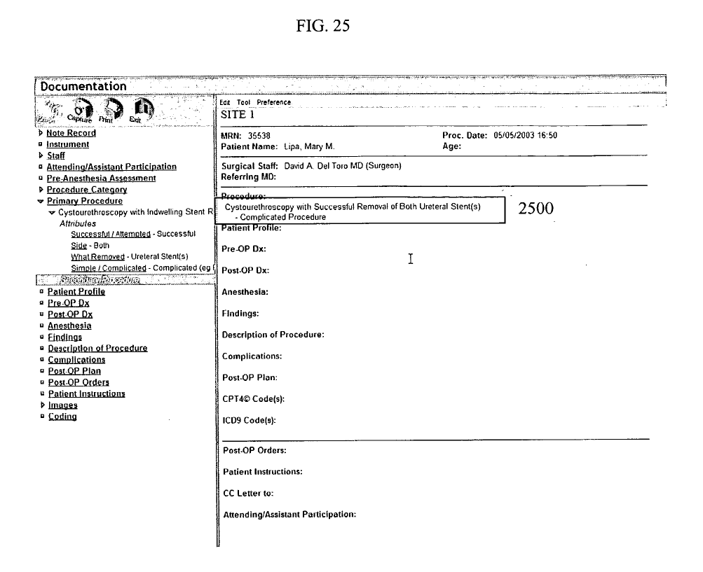

The physician is next presented with a screen illustrated in FIG. 25 showing the structured completed natural procedure label controlled for coding. The system's anticipatory interface navigates the system to the next step in the documentation process. This navigation is not illustrated in FIG. 25. The number of attributes in the above description of embodiments can vary based on the procedure being documented. The above description is representative of the other methods that are used to create a natural procedure label controlled for coding embodied in this invention. Other methods may involve the modifying of the natural procedure label based upon relevant information documented in nodes 1807 of the report area 1802.

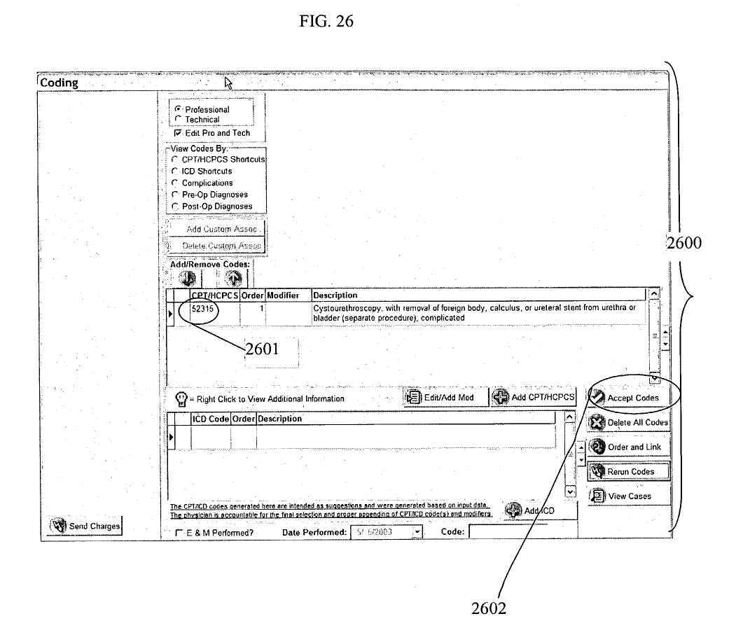

The physician is next prompted by the anticipatory physician interface to document additional aspects of the procedure documentation. Referring back to FIG. 18, the physician uses the navigation tree 1801, comprised of several nodes 1809 and 1807 that represent distinct areas of report documentation to complete the documentation. Additional data is entered via the navigation tree 1801 by clicking on other nodes 1807. The data entered is automatically copied to subsection 1803 and subsection 1804 of the report area 1802. The Coding node 1810 is clicked when the physician is finished with their documentation and the physician is presented with a screen illustrated in FIG. 26.

After the physician clicks the coding node 1810 several sophisticated interactions take place between the navigation tree 1801 and the database server's 3900 stored procedures 3901 and data tables 3902.

The first system operation occurs within the stored procedure AIMP 4003 (FIG. 40). The stored procedure AIMP 4003 is the component of the system that links the natural procedure label to a non E & M CPT code. The stored procedure AMIP is intrinsically an ontological inference engine that links the natural procedure label to a unique non E & M CPT codes by applying inference logic against data stored in the database.

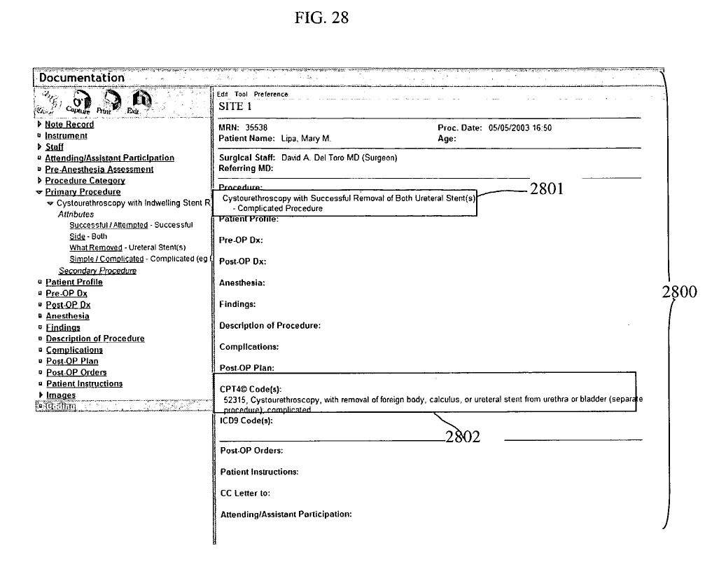

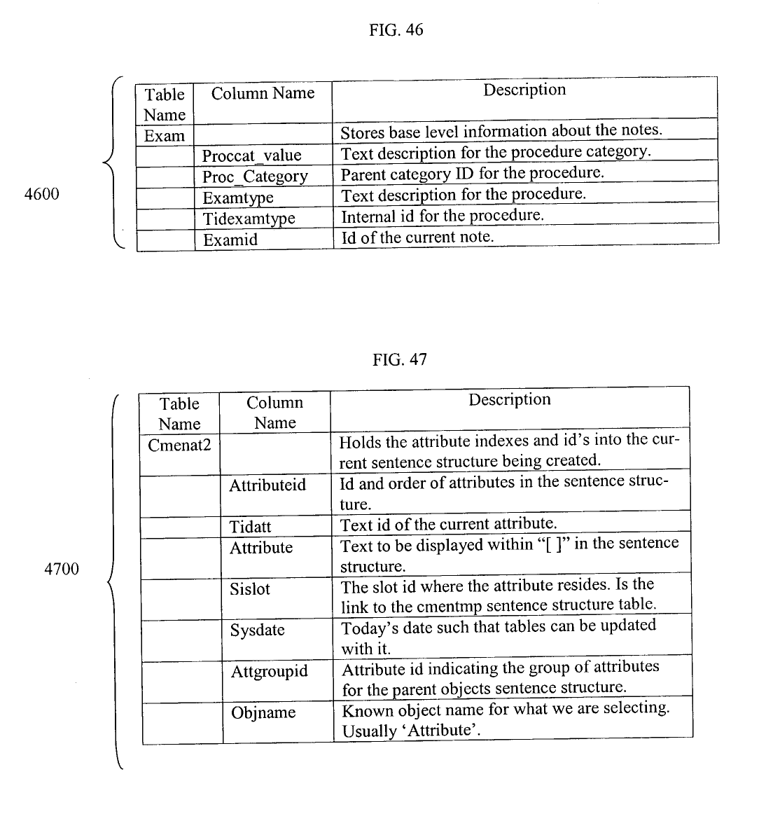

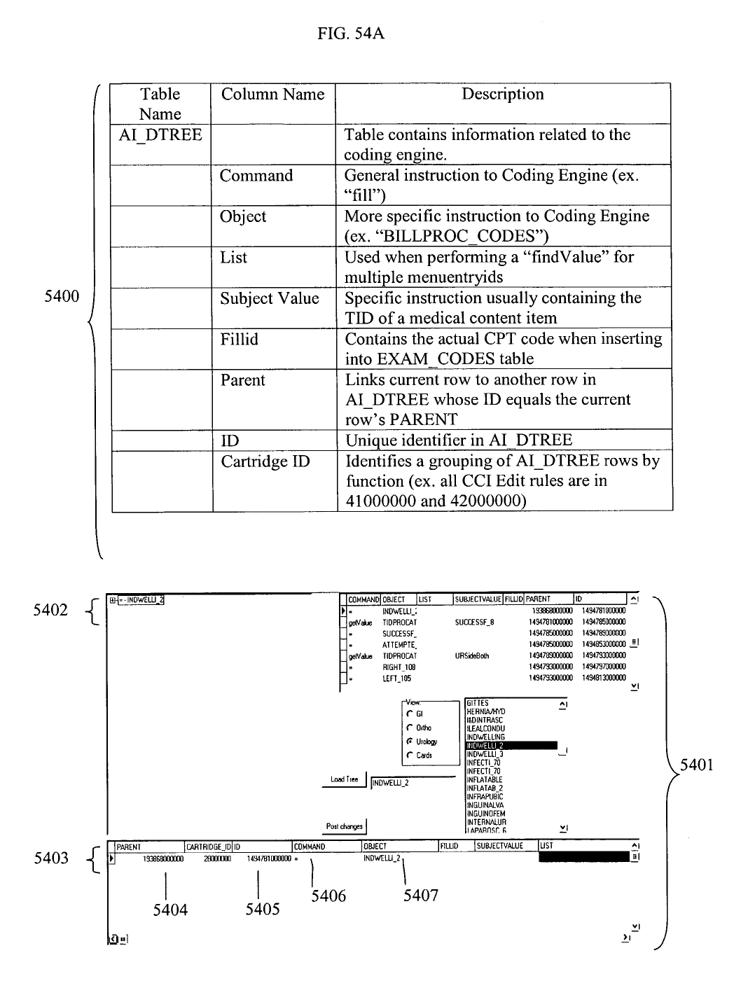

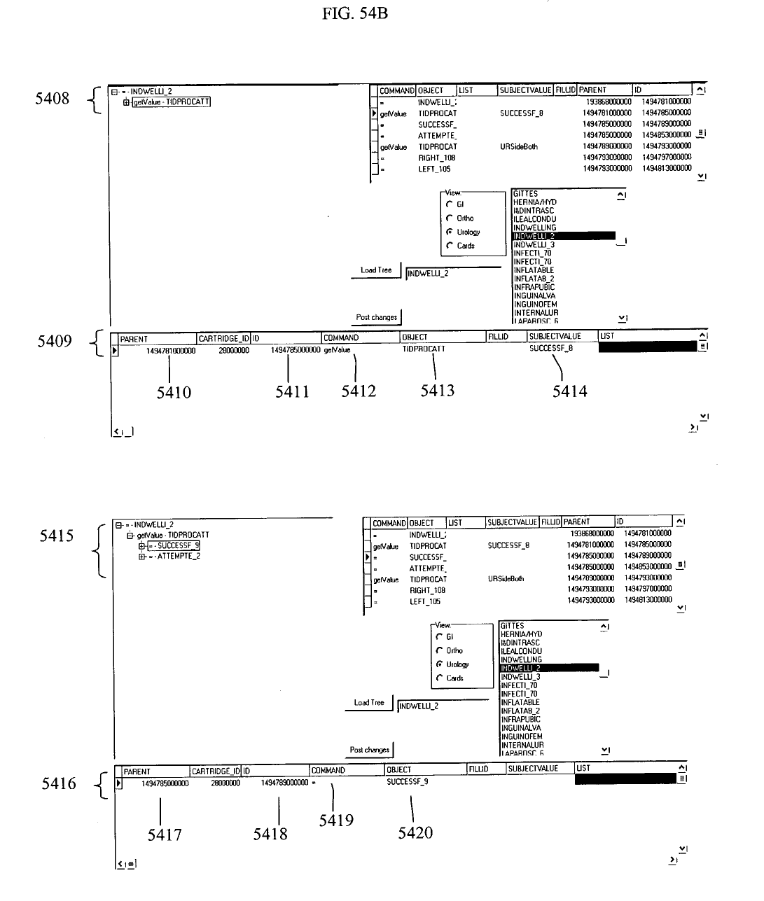

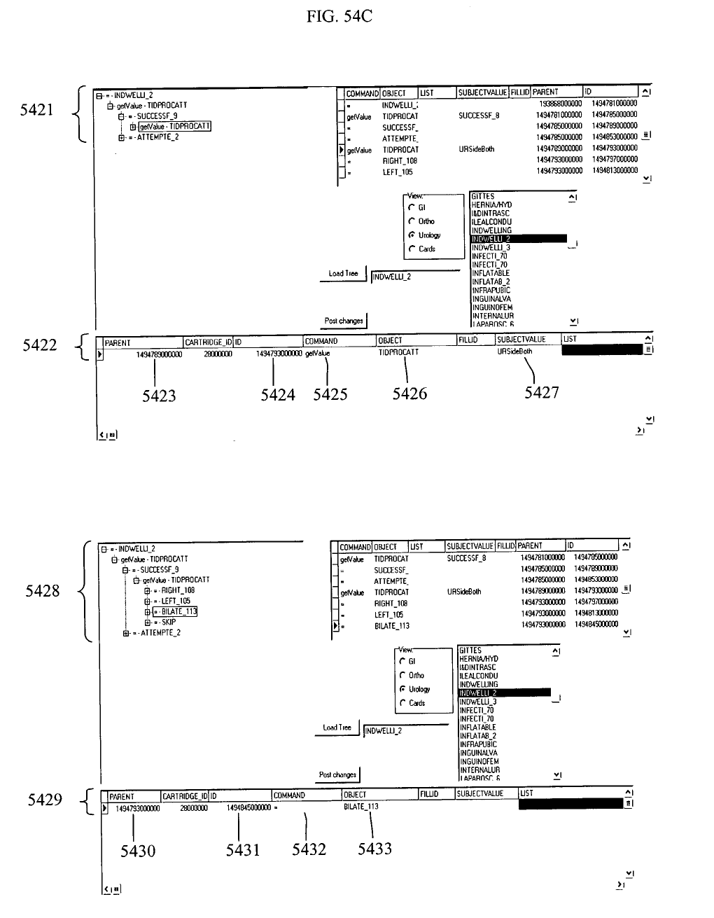

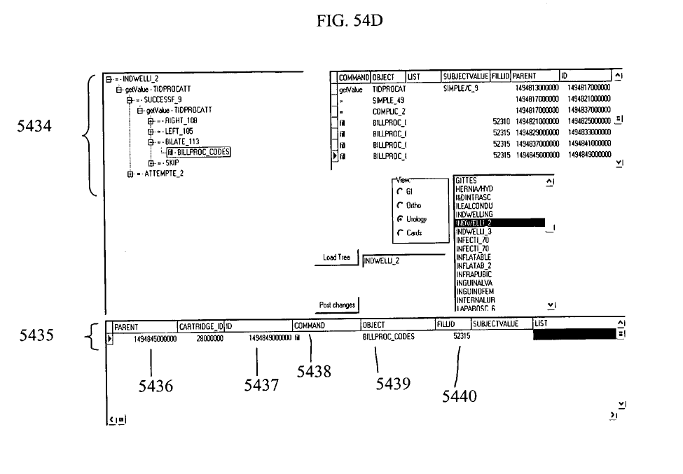

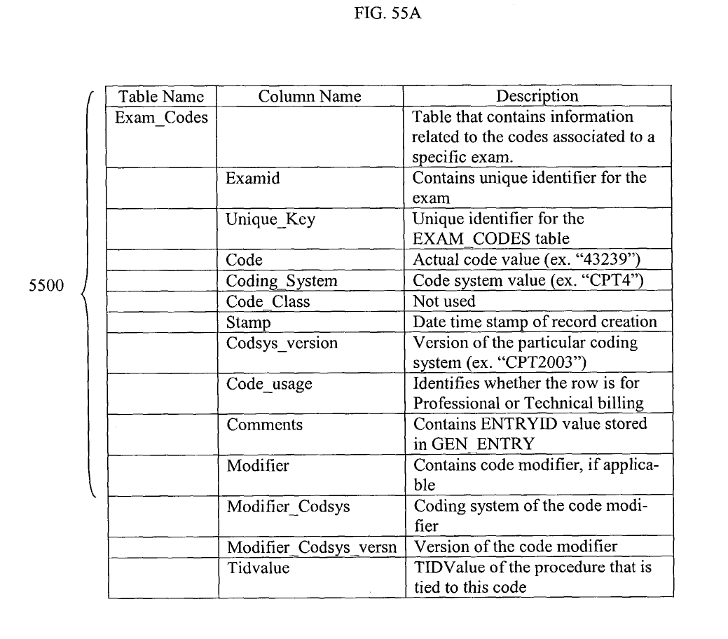

Referring to FIG. 54A, the first system operation that occurs within the ontological interface engine 5401 locates the parent node 5404 for procedure type 5407 in the table AI_DTREE 5400 which matches the procedure type 4923 (FIG. 49) stored in the exam table 4600 (FIG. 46). The ontological interference engine 5401 is not displayed to the physician and the screen shots are presented to illustrate the data retrieved and logic that is executed within the system which results in the natural procedure label 2801 tied to the correct CPT code 2802 (FIG. 28).

The first system operation returns a row of data 5403 that contains commands 5406 on how to proceed through the ontological inference engine 5401. The next system operation that occurs within the ontological inference engine 5401 is based on the value located in the command 5406 (FIG. 54A). In this example, the command is ‘=’ which instructs the ontological inference engine 5401 to retrieve a row of data that has a parent value 5410 which matches the ID value 5405. A row of data 5409 (FIG. 54B) is returned that contains commands 5412 on how to proceed through the ontological inference engine 5401.

The next system operation that occurs within the ontological inference engine 5401 is based on the value located in the command 5412 (FIG. 54B). In this example, the command is ‘getvalue’ which instructs the ontological inference engine 5401 to retrieve a row of data in the exam table 4600 (FIG. 46) which matches the subject value 5414. A data value is retrieved 5016 (FIG. 50B) which is used to retrieve a row of data in AI_DTREE 5400 that matches ID value 5411 (FIG. 54B) with the Parent value 5417 and the retrieved value 5016 with the object value 5420 (FIG. 54B). A row of data 5416 (FIG. 54B) is returned that contains commands 5419 on how to next proceed through the ontological inference engine 5401.

The next system operation that occurs within the ontological inference engine 5401 is based on the value located in the command 5419 (FIG. 54B). In this example, the command is ‘=’ which instructs the ontological inference engine 5401 to retrieve a row of data that has a parent value 5423 which matches the ID value 5418 (FIG. 54B). A row of data 5422 (FIG. 54C) is returned that contains commands 5425 on how next to proceed through the ontological inference engine 5401.

The next system operation that occurs within the ontological inference engine 5401 is based on the value located in the command 5425 (FIG. 54C). In this example, the command is ‘getvalue’ which instructs the ontological inference engine 5401 to retrieve a row of data in the exam table 4600 (FIG. 46) which matches the subject value 5427 (FIG. 54C). A data value is retrieved 5108 (FIG. 51A) which is used to retrieve a row of data in AI_DTREE 5400 that matches ID value 5424 with the Parent value 5430 and the retrieved value 5108 with the object value 5427 (FIG. 54C). A row of data 5429 (FIG. 54C) is returned that contains commands 5432 on how to next proceed through the ontological inference engine 5401.

The next system operation that occurs within the ontological inference engine 5401 is based on the value located in the command 5432. In this example, the command is ‘=’ which instructs the ontological inference engine 5401 to retrieve a row of data that has a parent value 5436 (FIG. 54D) which matches the ID value 5431 (FIG. 54C). A row of data 5435 (FIG. 54D) is returned that contains commands 5438 on how next to proceed through the ontological inference engine 5401.

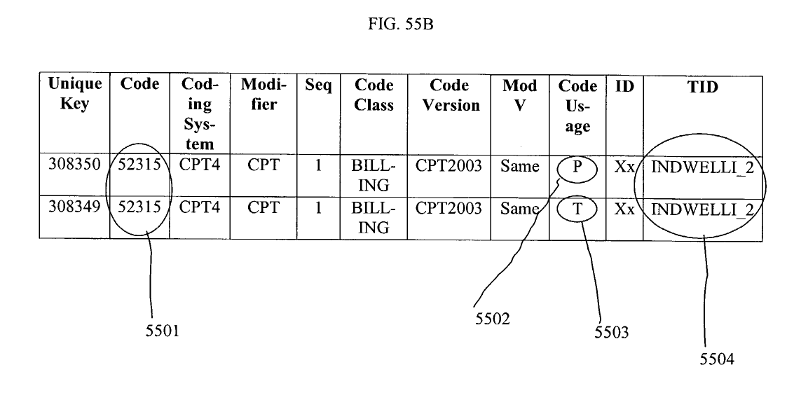

The next system operation that occurs within the ontological inference engine 5401 is based on the value located in the command 5438 (FIG. 54D). In this example, the command is ‘fill’ which instructs the ontological inference engine 5401 to populate the exam codes table 5500 with the value in fillid 5440 (FIG. 54D) and to end the ontological inference engine processing. The value of fillid 5440, ‘52315’ is the CPT code coupled to the natural procedure label 2601. Referring to FIG. 55B, the value of the fillid 5440, ‘52315’, is stored in the exam codes table 5500 in the code field 5501 (FIG. 55B) for procedure code of ‘INDWELLI_{—}2’ which is stored in the TID 5504. The data in exam codes 5500 is tied to a specific patient procedure identifier, (i.e., exam id).

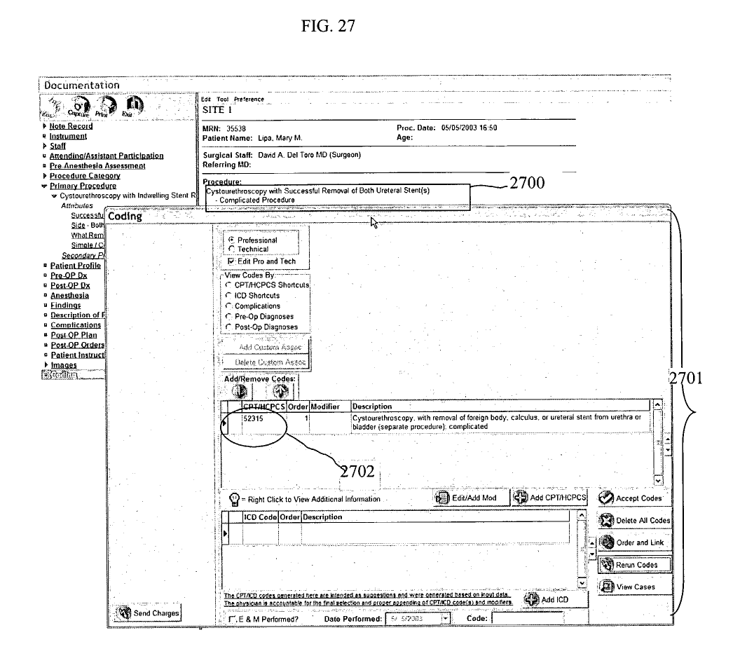

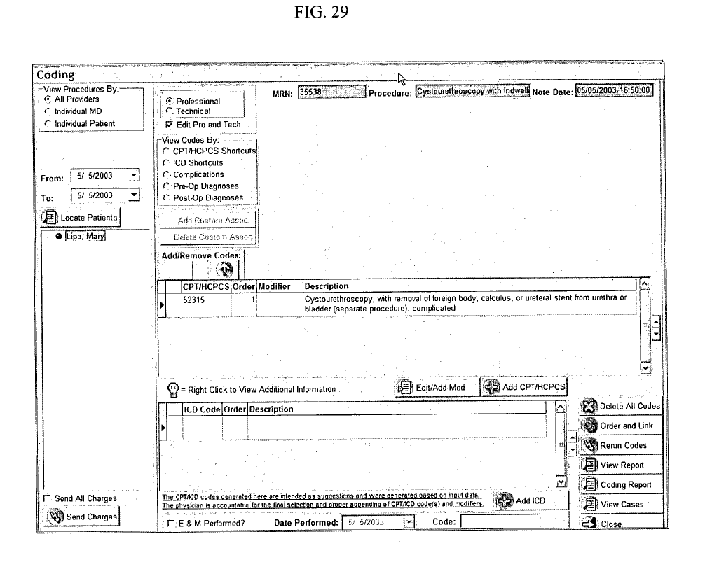

The ontological inference engine is complete and the physician is presented with the screen illustrated in FIG. 26. The coding form 2600 contains the CPT code 2601 that is coupled with the natural procedure label 2500 previously generated in this example (FIG. 27). The physician can modify, add or delete to the non E & M CPT codes. The physician can also document the relevant ICD codes that were part of this procedure documentation. Additionally, the physician may indicate the non E & M CPT code for the technical aspect of the CPT billing. When the physician is satisfied with the coding they click on the Accept Codes button 2702 and the form closes. The physician is next presented with a form 2800 that has a natural procedure label 2801 controlled for coding 2802 (FIG. 28). The coding form can also be accessed in our areas of the system (FIG. 29) that are engineered to be used by non physician coding personnel.

The method described above is illustrative of the coupling of a natural procedure label 2500 with a CPT code 2601. Alternative methods involve the coupling of several CPT codes with a natural procedure label, the presentation of CCl edits for multiple CPT codes, and the presentation of CPT modifiers.

Those skilled in the art will recognize that the embodiments disclosed herein are exemplary in nature and that various changes can be made without departing from the scope and the spirit of this invention. Such various changes would become clear to one of ordinary skill in the art after inspection of the specification and the drawings. In that regard, as many changes as are possible to the embodiments of this invention utilizing the teachings thereof, the descriptions above, and the accompanying drawings should be interpreted in the illustrative and not the limited sense. The invention therefore is not to be restricted except within the spirit and scope of any appended claims.

The invention is by no means restricted to the embodiment shown. Many alternative versions are feasible in respect of the actual construction of the means used. The invention is not limited to procedure descriptions completed for procedures performed in Urology but in fact can be used to assign a natural procedure label to all of the non E & M CPT codes currently in place and developed in future releases. Furthermore, alternative user interfaces are in place and can be created in the future that couple a natural procedure label to a plurality of procedure terminologies and non E & M CPT codes. It is particularly to be noted that the invention is not restricted either to a special type of data or to special configurations of data.

What is claimed is:

1. A method for documenting a medical procedure, comprising steps of:
(a) recording a medical procedure description; and
(b) constructing a natural procedure label based on the medical procedure description, wherein the natural procedure label concisely summarizes said medical procedure description.

2. The method of claim 1, wherein said step of constructing the natural procedure label comprises steps of:
(a) accessing a first procedures representations database having a plurality of procedure term and attributes representations;
(b) selecting a procedure term and attributes representation from the first procedure database, the selected procedure term and attributes representation associated with the medical procedure description; and
(c) constructing the natural procedure label using the selected procedure term and attributes representation.

3. The method of claim 2, wherein said step of accessing a procedures representations database comprises:
(a) accessing a second database of procedure terminologies, the procedure terminologies interconnected to the first procedures representations database.

4. The method of claim 3, wherein said step of accessing the second procedures representations database comprises:
(a) accessing a third database of non E & M CPT codes, said database of non E & M CPT codes interconnected to the second procedures representations database.

5. The method of claim 4, wherein said step of selecting the procedure term and attributes representation further comprises:
(a) automatically selecting a plurality of non E & M CPT codes from said database of non E & M CPT codes.

6. The method of claim 5, wherein said step of constructing the natural procedure label comprises:
(a) associating a non E & M CPT code to the natural procedure label, wherein the natural procedure label and the non E & M CPT code concisely summarize the medical procedure description.

7. A method for documenting a medical procedure, comprising steps of:
(a) recording a medical procedure description;
(b) accessing a first procedures representations database having a plurality of procedure term and attributes representations;
(c) selecting a procedure term and attributes representation from the first procedure representations database, the selected procedure term and attributes representation associated with the medical procedure description; and
(d) constructing a natural procedure label using the recorded medical procedure description, wherein the natural procedure label concisely summarizes the medical procedure description.

8. The method of claim 7 further comprising:
(e) accessing a second database of procedure terminologies.

9. The method of claim 8 further comprising:
(f) accessing a third database of non E & M CPT codes.

10. The method of claim 9 further comprising:
(g) automatically selecting a plurality of non E & M CPT codes from the third database of non E & M CPT codes; and
(h) associating a non E & M CPT code to the natural procedure label, wherein the natural procedure label and the non E & M CPT code concisely summarize the medical procedure description.

11. A documentation system for medical procedure descriptions, said system comprising:
(a) a computing device;
(b) a user interface residing on said computing device for recording a medical procedure description, said user interface arranged to construct a natural procedure label, wherein said natural procedure label concisely summarizes said medical procedure descriptions.

12. The system of claim 11 further comprising a first database residing on said computing device and connected to said user interface, said first database comprising a plurality of medical procedure descriptions and programming logic.

13. The system of claim 12 further comprising a second database residing on said computing device and connected to said user interface, said second database comprising a plurality of procedures terms and attributes representations.

14. The system of claim 13 further comprising an anticipatory user interface arranged to access said procedures terms and attributes representations residing on said user interface.

15. The system of claim 14 further comprising an ontology inference engine residing on said user interface; and a third database residing on said computing device, said third database having a plurality of non E & M CPT codes.

16. The system of claim 15 further comprising means for automatically selecting a plurality of non E & M CPT codes from said third database and means for associating said non E & M CPT codes to said natural procedure label, wherein said natural procedure label and said non E & M CPT code concisely summarize said medical procedure description.

17. A documentation system for medical procedure descriptions, the system comprising:
(a) a computing device;
(b) a user interface residing on said computing device for recording a medical procedure description, said user interface arranged to construct a natural procedure label, wherein said natural procedure label concisely summarizes said medical procedure description;
(c) a first database residing on said computing device and connected to said user interface, said first database comprising a plurality of medical procedure descriptions and programming logic;
(d) a second database residing on said computing device and connected to said user interface, said second database comprising a plurality of procedures terms and attributes representations;
(e) an anticipatory user interface for accessing said procedure terms and attributes representations;
(f) an ontology inference engine residing on said user interface and said computing device;
(g) a third database residing on said computing device, said third database comprising a plurality of non E & M CPT codes; and
(h) means for automatically selecting a plurality of non E & M CPT codes from said third database and associating said non E & M CPT codes to said natural procedure label, wherein said natural procedure label and said non E & M CPT code concisely summarize said medical procedure description.

18. The system of claim 17, wherein said user interface and said first, second, and third databases operate on a plurality of computing devices operating on a networked computer system within a healthcare facility's wide area network.

19. The system of claim 18, wherein said user interface and said first, second and third databases operate on a plurality of computing devices operating on said networked computer system within and outside of the healthcare facility's wide area network.

20. The system of claim 19, wherein said user interface and said first, second and third databases have a functionality distributed to a plurality of said computing devices operating on said networked computer system within the healthcare facility's wide area network.

21. The system of claim 20, wherein said user interface and said first, second and third databases have a functionality distributed to a plurality of computing devices operating on said networked computer system within and outside of the healthcare facility's wide area network.

22. A documentation system for medical procedure descriptions, said system comprising:
(a) a computing device;
(b) a user interface residing on said computing device for recording a medical procedure description, said user interface arranged to construct a natural procedure label, wherein said natural procedure label concisely summarizes said medical procedure description;
(c) a first database residing on said computing device and connected to said user interface, said first database comprising a plurality of medical procedure descriptions and programming logic;
(d) a second database residing on said computing device and connected to said user interface, said second database comprising a plurality of procedures terms and attributes representations;
(e) an anticipatory user interface for accessing said procedure terms and attributes representations residing on said user interface;
(f) an ontology inference engine residing on said user interface and said computing device;
(g) a third database residing on said computing device, said third database comprising a plurality of non E & M CPT codes;
(h) means for automatically selecting a plurality of non E & M CPT codes from said third database and associating said non E & M CPT codes to said natural procedure label, wherein said natural procedure label and said non E & M CPT code concisely summarize said medical procedure description; and
(i) said user interface and said first, second and third databases operating on a plurality of computing devices operating on a networked computer system within a healthcare facility's wide area network.

23. The system of claim 22, further comprising:
(j) said user interface and said first, second, and third databases have a functionality being distributed to a plurality of computing devices operating on said networked computer system within the healthcare facility's wide area network.

24. A documentation system for medical procedure descriptions comprising:
(a) a computing device;
(b) a user interface residing on said computing device for recording a medical procedure descriptions, said user interface arranged to construct a natural procedure label, wherein said natural procedure label concisely summarizes said medical procedure description;
(c) a first database residing on said computing device and connected to said user interface, said first database comprising a plurality of medical procedure descriptions and programming logic;
(d) a second database residing on said computing device and connected to said user interface, said second database comprising a plurality of procedures terms and attributes representations;
(e) an anticipatory user interface for accessing said procedure terms and attributes representations residing on said user interface;
(f) an ontology inference engine residing on said user interface and said computing device;
(g) a third database residing on said computing device, said third database comprising a plurality of non E & M CPT codes;
(h) means for automatically selecting a plurality of non E & M CPT codes from said third database and associating said non E & M CPT codes to said natural procedure label, wherein said natural procedure label and said non E & M CPT code concisely summarize said medical procedure description; and
(i) said user interface and said first, second and third databases operating on a plurality of computing devices operating on a networked computer system within and outside of a healthcare facility's wide area network.

25. The system of claim 24 further comprising:
(j) said user interface and said first, second and third databases have a functionality distributed to a plurality of said computing devices operating on said networked computer system within the healthcare facility's wide area network.

26. The system of claim 24 further comprising:
(j) said user interface and said first, second and third databases have a functionality being distributed to a plurality of computing devices operating on said networked computer system within and outside of the healthcare facility's wide area network.

27. The system of claim 17 wherein any of said first, second and third databases is selected from the group consisting of relational, Object, text based, XML based, object-relational, and flat file produced by vendors including but not limited to Oracle, Microsoft, Sybase, IBM, Computer Associates, and Informix.

28. The system of claim 17 wherein said computing device is selected from the group consisting of Windows/Intel PC, PocketPC, Laptop PC, Tablet PC, Apple Computers, Citrix ICA computers, Unix Workstations, and Linux workstations produced by vendors including but not limited to Sun, IBM, Compaq, Dell, Apple, and HP.

29. The system of claim 17 wherein said user interface is selected from the group consisting of traditional Windows clients, browser/HTML based, J2EE, JAVA, XML based, Windows Forms, Windows NET, speech recognition, speech navigation, and Pocket PC interfaces produced by vendors including but not limited to IBM, Novell, Apple, Sun, and Microsoft.

30. The system of claim 22 wherein any of said first, second and third databases is selected from the group consisting of relational, Object, text based, XML based, object-relational, and flat file produced by vendors including but not limited to Oracle, Microsoft, Sybase, IBM, Computer Associates, and Informix.

31. The system of claim 22 wherein said computing device is selected from the group consisting of Windows/Intel PC, PocketPC, Laptop PC, Tablet PC, Apple Computers, Citrix ICA computers, Unix Workstations, and Linux workstations produced by vendors including but not limited to Sun, IBM, Compaq, Dell, Apple, and HP.

32. The system of claim 22 wherein said networked computer system is selected from the group consisting of TPC/IP, Peer-to-Peer, Wireless, RPC, IPX/SPX, DLC, and Windows Networking produced by vendors including but not limited to IBM, Novell, Apple, RedHat, Unix, BSD, and Microsoft.

33. The system of claim 22 wherein said user interface is selected from the group consisting of traditional Windows clients, browser/HTML based, J2EE, JAVA, XML based, Windows Forms, Windows NET, speech recognition, speech navigation, and Pocket PC interfaces produced by vendors including but not limited to IBM, Novell, Apple, Sun, and Microsoft.

34. The system of claim 24 wherein any of said first, second and third databases is selected from the group consisting of relational, Object, text based, XML based, object-relational, and flat file produced by vendors including but not limited to Oracle, Microsoft, Sybase, IBM, Computer Associates, and Informix.

35. The system of claim 24 wherein said computing device is selected from the group consisting of Windows/Intel PC, PocketPC, Laptop PC, Tablet PC, Apple Computers, Citrix ICA computers, Unix Workstations, and Linux workstations produced by vendors including but not limited to Sun, IBM, Compaq, Dell, Apple, and HP.

36. The system of claim 24 wherein said networked computer system is selected from the group consisting of TPC/IP, Peer-to-Peer, Wireless, RPC, IPX/SPX, DLC, and Windows Networking produced by vendors including but not limited to IBM, Novell, Apple, RedHat, Unix, BSD, and Microsoft.

37. The system of claim 24 wherein said user interface is selected from the group consisting of traditional Windows clients, browser/HTML based, J2EE, JAVA, XML based, Windows Forms, Windows .NET, speech recognition, speech navigation, and Pocket PC interfaces produced by vendors including but not limited to IBM, Novell, Apple, Sun, and Microsoft.
